(19) United States
(12) Patent Application Publication
(10) Pub. No.: US 2002/0009602 A1
(43) Pub. Date: Jan. 24, 2002

(54) Method and apparatus of fabricating glass molded article, method of fabricating glass substrate, and information recording medium

(75) Inventors: Teruki Kitayama, Oume-shi (JP); Akira Murakami, Akiruno-shi (JP); Takumi Yata, Hamura-shi (JP); Junji Yoshida, Fussa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HOYA CORPORATION, Shinjuku-ku (JP)

(21) Appl. No.: 09/803,900

(22) Filed: Mar. 13, 2001

(30) Foreign Application Priority Data
Mar. 13, 2000 (JP) 2000-069069

(51) Int. Cl. B32B 3/02; B32B 15/00; B32B 17/06

(52) U.S. Cl. 428/432; 428/64.4

(57) ABSTRACT

To provide a fabricating method and a fabricating apparatus of a planar glass molded article and a glass substrate capable of fabricating a thinner planer glass molded article in a state having small warp without extending cycle time and an information recording medium, a method of providing a planar glass molded article by pressing a glass material to be molded by using molds at least including an upper mold and a lower mold, includes a step of supplying the glass material to be molded having temperature higher than a glass transition point to a molding surface of the lower mold, a step of molding planar glass by press-molding the supplied glass material to be molded by the lower mold and the upper mold, a step of removing the upper mold from the planar glass and taking out the planar glass on the molding surface of the lower mold from the molding surface of the lower mold, a step of cooling the planar glass to temperature lower than a strain point of the glass, and a step of annealing the provided planar glass. A method of fabricating a glass substrate by at least polishing the planar glass provided by the method. An information recording medium using the glass substrate.

### BACKGROUND OF THE INVENTION

1. Field of the Invention

The present invention relates to a fabricating method of a glass molded article used as a substrate of an information recording medium such as a magnetic recording medium, a magneto-optical recording medium or an optical recording medium, or as planer glass of a filter of a camera or a mask blank and fabricated by press-molding thin planar glass, for example, a thickness equal to or smaller than about 3 mm and a fabricating apparatus used in the fabricating method. Further, the invention relates to a fabricating method of a glass substrate constituting a substrate by lapping and polishing the glass molded article and an information recording medium such as a magnetic recording medium, a magneto-optical recording medium or an optical recording medium having the substrate.

2. Background Art

Recently, there has been frequently used a glass substrate as a substrate of an information recording medium such as a magnetic recording medium. Conventionally, such a glass substrate has been fabricated by a method of cutting the substrate from planar glass. However, in recent years, in place of the above-described method, there is adopted a method of directly press-molding the substrate from molten glass by using molds, that is, a direct press method.

As the direct press method, there is a method disclosed, for example, Japanese Patent Laid-Open No. 105458/1993. The method is a method of fabricating a glass product having a disk-like shape in a near final shape having small warp by pressing glass by a mold formed with a mold-releasing agent at molding surfaces thereof at temperature at which temperature of raw material glass is equal to or lower than a softening point for a sufficient period of time until upper and lower molds and the glass are thermally balanced.

However, according to the method, it is necessary to press-mold the glass for a sufficient period of time until the upper and lower molds and the glass are thermally balanced at the temperature at which the temperature of the raw material glass is equal to or lower than the softening temperature and there poses a problem that the time period required for press-molding is long and mass production performance is poor.

In contrast thereto, in recent times, there has been enhanced a request for realizing high recording density of a magnetic recording medium and there is requested a substrate having warp smaller than that in a conventional one. Particularly, there has been requested to provide high flatness in a substrate for a magnetic recording medium capable of dealing with an MR head. Therefore, when there is fabricated a glass substrate for a magnetic recording medium for dealing with an MR head by using a method described in Japanese Patent Laid-Open No. 105458/1993, it is necessary to lap and polish a glass substrate provided by press-molding to meat predetermined specification. The lapping operation is carried out in a state in which thin planar glass is put between lapping plates from both faces under pressure. However, the thinner the thickness of the planar glass, in the more bent state, the glass is lapped and accordingly, it is difficult to resolve warp of the planar glass. When the thin planar glass is removed from the lapping plates after lapping and pressure is released from the both faces of the planar glass, the bending is released and there poses a problem that the warp before lapping recovers. Therefore, when thin planar glass is lapping, pressure applied to the planar glass must be adjusted always finely such that the planar glass is not bent, as a result, lapping time is prolonged.

In this way, when there is fabricated a glass substrate for a magnetic recording medium for dealing with an MR head by using the method described in Japanese Patent Laid-Open No. 105458/1993, there poses a problem that not only the time period required for press-molding is long but also mass production performance of thin planer glass with excellent flatness cannot be promoted.

As a method of resolving such a problem, there is proposed a method described Japanese Patent Laid-Open No. 236831/1998. The method is specifically characterized in correcting warp of glass by pressing thin planar glass in a formable state after press-molding by a pair of flat bases (hereinafter, referred to as correcting press).

The glass corrected with the warp is taken out from a lower mold after having been cooled to temperature at which the glass is not deformed by external force, and immediately transferred to a furnace for annealing and the strain is removed.

According to the method, after pressing, only an upper mold is removed from the molded glass and the molded glass is cooled to temperature at which the glass can be taken out in a state in which the glass is mounted on a molding surface of the lower mold. This is because the glass is in a temperature range in which the glass is deformable by external force at a time point at which the glass is removed from the upper mold and when the glass is taken out from the lower mold under the state, the molded glass is deformed by force exerted to the glass.

Although at the time point at which the upper mold has been evacuated, temperature of the lower mold mounted with the glass is dropping, the lower mold is yet in a considerably high temperature state and cooling of the molded glass is progressed by heat conduction mainly from a face there of which is not brought into contact with the mold. That is, at the time point, there is a significant difference between heat conduction of the glass from the face in contact with the molding surface of the lower mold and heat radiation of the glass from the face removed from the upper mold in contact with atmosphere. The state continues until the glass is taken out from the lower mold. Therefore, at a time point of taking out the glass from the lower mold, the temperature of the molded glass on the side of the face in contact with the molding surface of the lower mold, is brought into a state of considerably lower than the temperature on the side of the face in contact with the atmosphere (face molded by the upper mold). The temperature difference between the two faces opposed to each other, constitutes a cause of producing the warp in the glass.

Hence, it seems that the warp of the planar glass can be reduced by rapidly cooling the lower mold to thereby reduce the temperature difference between the two faces of the molded glass opposed to each other. However, in order to rapidly cool the lower mold, for example, it is necessary to devise to circulate a cooling medium in the mold, further, it is necessary to uniformly cool the mold and accordingly, it is very difficult technically. Therefore, it is not practical to reduce the warp of the planar glass by forcibly cooling the lower mold to thereby make temperature drop of the lower mold substantially equal to temperature drop of the atmosphere.

Further, in fact, the warp of the planar glass cannot be corrected by the correcting press after taking out the glass from the lower mold. Because whereas the glass can be corrected by the correcting press only when the temperature of the glass is higher than the glass transition point of the glass, the glass is taken out from the lower mold normally after temperature of the glass becomes temperature lower than the glass transition point such that the glass is not deformed by taking out the glass from the lower mold. That is, the warp cannot be corrected by the correcting press since the temperature of the glass taken out from the lower mold is lower than the glass transition point.

Hence, it is an object of the invention to provide a fabricating method and a fabricating apparatus of a planar glass molded article capable of fabricating in a state having smaller warp even in a planar glass molded article having a thinner thickness without prolonging a fabrication time period (cycle time) (in a shorter period of time).

Further, it is an object of the invention to provide a fabricating method of a glass substrate using a glass molded article fabricated by the above-described fabricating method.

In addition thereto, it is an object of the invention to provide an information recording medium using the above-described glass substrate.

### SUMMARY OF THE INVENTION

After a result of intensive investigation on the above-described problem, the inventors have found that warp of glass can be reduced by rapidly cooling thin planar glass having a temperature difference between two faces thereof in a range of not destructing the planar glass before an annealing step and making temperature of the glass temporarily lower than the strain point. Further, the inventors have found that an amount of warp of planar glass produced by annealing can be reduced by bringing planar glass into a vertically-placed state in an annealing step which is carried out by bringing the glass temporarily in a temperature range higher than the strain point.

The invention has been carried out based on the above-described knowledge and it is an object thereof to provide a method of fabricating a thin planar glass molded article reducing the warp, a method of fabricating a glass substrate for constituting a glass substrate by working the above-described molded product and an information recording medium using the glass substrate.

According to an aspect of the invention, there is provided a method of fabricating a glass molded article which is a method of providing a planar glass molded article by pressing a glass material to be molded by using a mold at least comprising an upper mold and a lower mold, the method comprising:

a step of supplying the glass material to be molded having temperature higher than a glass transition point onto a molding surface of the lower mold (supplying step);

a step of molding planar glass by press-molding the supplied glass material to be molded by the lower mold and the upper mold (pressing step);

a step of removing the upper mold from the planar glass and thereafter taking out the planer glass on the molding surface of the lower mold from the molding surface of the lower mold (removing step);

a step of cooling the planar glass to temperature lower than a strain point of the glass (cooling step); and

a step of annealing the provided planar glass (annealing step).

In the aspect of the invention, the glass material to be molded supplied onto the molding surface of the lower mold can be molten glass. Further, it is preferable in view of capable of reducing an amount of warp of the planar glass caused by the annealing operation to carry out the cooling step and/or annealing step by placing the planar glass vertically. Further, it is preferable to correct warp of the planar glass by applying external force to the planar glass after removing the upper mold from the planar glass and until the planar glass is taken out from the molding surface of the lower mold. Further, a thickness of the planar glass molded article can be equal to or smaller than 4 mm. Further, it is preferable in view of shortening cycle time that in a method of continuously fabricating a planar glass product by repeating a series of steps from the supplying step to the annealing step, the lower mold after taking out the planar glass from the molding surface, is adjusted to predetermined temperature and thereafter recycled to the supplying step.

Further, according to a second aspect of the invention, there is provided a method of fabricating a glass molded article which is a method of providing a planar glass molded article by pressing a glass material to be molded by using molds at least comprising an upper mold and a lower mold, taking out provided planar glass from the molds and annealing the planar glass, wherein the planar glass is annealed by pressing the planar glass vertically.

According to the aspect of the invention, the annealing operation can be carried out by transferring the planar glass in a state of being placed vertically on the transferring means in an annealing furnace.

Further, according to another aspect of the invention, there is provided a method of fabricating a glass substrate for providing a glass substrate by at least polishing main faces of the glass molded article provided by the method of fabricating a glass molded article according to the invention.

Further, according to another aspect of the invention, there is provided an information recording medium having the glass plate provided by the method of fabricating a glass substrate according to the invention and an information recording layer provided at the principal face to the glass substrate. Further, according to the aspect of the invention, the information recording layer may be provided directly on the principal face of the glass substrate or may be provided indirectly on the surface of the glass substrate via a layer different from the information recording layer.

Further, according to another aspect of the invention, there is provided an apparatus of fabricating a planar glass molded article which an apparatus of fabricating a planar glass molded article comprising molds at least comprising an upper mold and a lower mold for molding planar glass by pressing a glass material to be molded and an annealing furnace for annealing the planar glass, the apparatus comprising a transfer unit for transferring the planar glass to the annealing furnace after temperature of the planar glass taken out from the molds becomes lower than a strain point of the glass.

In the above-described apparatus, it is preferable that the transfer unit is means for transferring the planar glass in a vertically-placed state.

Further, according to another aspect of the invention, there is provided an apparatus of fabricating a planar glass molded article which is an apparatus of fabricating a planar glass molded article comprising molds at least comprising an upper mold and a lower mold for molding planar glass by pressing a glass material to be molded and an annealing furnace for annealing the planar glass, the apparatus comprising a transfer unit for transferring the planar glass in a vertically-placed state in the annealing furnace.

### BRIEF DESCRIPTION OF THE DRAWINGS

FIG. 1 is an outline diagram of temperature change of glass according to an embodiment of a fabricating method of planar glass of the invention;

FIG. 2 is a flowchart showing a fabricating method of planar glass according to the invention;

FIG. 3 is a plane view of an upper mold apparatus and a lower mold apparatus used in the method of FIG. 2;

FIG. 4 is a plane view showing other example of a relationship between an upper mold and a high frequency coil;

FIG. 5 is a sectional view showing a specific example of an upper mold and a lower mold of the apparatus of FIG. 3;

FIG. 6 is a plane view and a bottom view of the upper mold and the lower mold of FIG. 5;

FIGS. 7A and 7B are sectional views for explaining press-molding;

FIGS. 8A and 8B are sectional views for explaining the press-molding;

FIGS. 9A and 9B are sectional views for explaining the press-molding;

FIG. 10 is a sectional view for explaining press-molding and warp correcting press;

FIG. 11 is a sectional view showing disk-like glass fabricated by an embodiment of the invention;

FIG. 12 is a sectional view showing other example of an upper mold for warp correcting press;

FIG. 13 is a sectional view showing to enlarge portion A of FIG. 12;

FIG. 14 is a bottom view showing a press surface of an upper mold for warp correcting press of FIG. 12;

FIG. 15 is a sectional view showing other example of thin planar glass according to the invention and a lapping step;

FIG. 16 is a sectional view showing other example of an upper mold for warp correcting press; and

FIG. 17 is an outline view of a fabricating apparatus of a planar glass molded article having molds, an annealing furnace and a transfer unit.

### DETAILED DESCRIPTION OF THE PREFERRED EMBODIMENTS

A first fabricating method of a glass molded article according to the invention is a method of providing a planar glass molded article by pressing a glass material to be molded by using molds comprising at least an upper mold and a lower mold and comprises a supplying step, a pressing step, a taking out step, a cooling step and an annealing step in this order.

According to the first fabricating method of the invention, in the taking out step, the planar glass removed from the upper mold and disposed above the molding surface of the lower mold, is taken out from the molding surface of the lower mold. More specifically, it is preferable that after removing the upper mold from the planar glass, the planar glass disposed on the molding surface of the lower mold is cooled to a state in which the planar glass is not deformed by external force and thereafter, the planar glass is taken out from the molding surface of the lower mold. In the thin planar glass cooled to temperature capable of being taken out from the lower mold in the state of being mounted on the lower mold, there is produced a temperature difference between a side of a face thereof molded by the lower mold and a side of a face thereof molded by the upper mold. However, in the taking out step, the glass is cooled to the state in which the glass is not deformed by external force in taking out from the lower mold and accordingly, warp of the planar glass is not increased and the warp can be reduced.

### Supplying Step

In the supplying step, the glass material to be molded having temperature higher than the glass transition point is supplied onto the molding surface of the lower mold. The glass material to be molded is provided with temperature higher than the glass transition point and accordingly, at the successive pressing step, the glass material to be molded is pressed by using molds comprising at least an upper mold and a lower mold. Specifically, the glass material to be molded is preferably glass in a molten state (viscosity of glass falls in a range of 10² through 10³ poises). By directly pressing molten glass, there is dispensed with an extra step of fabricating a preform as in a method of heating and press-molding glass gob and thin planer glass can be produced with high productivity.

The method of directly press-molding molten glass is referred to as direct press and according to the direct press, it is necessary to press-mold glass before the viscosity of the glass is significantly increased (before temperature of the glass is significantly dropped) since molten glass is supplied onto the lower mold. Therefore, when glass in a molten state is used as the glass material to be molded, a difference in temperature during a time period from press-molding until the molded glass is taken out from the lower mold, becomes significant and there is comparatively increased a temperature difference between the temperature of glass on the side of a face thereof molded by the lower mold and temperature of glass on the side of a face thereof molded by the upper mold in taking out the lower mold. In the molding operation in which a difference between temperature on the side of the face molded by the upper mold and temperature on the side of the face molded by the lower mold is large in this way, the warp after removing the glass from the lower mold is increased. However, according to the fabricating method of the invention capable of reducing the warp by carrying out the cooling step, even when the molten glass is pressed, the warp of the glass can be reduced, which is extremely effective for the direct press.

### Pressing Step

In the pressing step, the planar glass is produced by press-molding the glass material to be molded supplied onto the molding surface of the lower mold by the lower mold and the upper mold.

Temperature of the upper mold and temperature of the lower mold used in press-molding are pertinently set in view of kind of glass, removing performance of glass and damage of the molds. Incidentally, it is preferable that temperature of the upper mold falls in a range of 250 through 450° C. and temperature of the lower mold falls in a range of 350 through 550° C. By using the molds in the temperature ranges, glass is sufficiently elongated in the molds to be able to be molded and seizure or pasting of the molds is not caused because the temperature is excessively high. It is preferable that temperature of the upper mold is the same as temperature of the lower mold or lower than temperature of the lower mold by 50 through 100° C. Further, the molds can be provided with a cylindrical mold for guiding the upper and the lower mold or/and the upper mold other than the lower mold and the upper mold and in this case, it is preferable that temperature of the cylindrical mold (sleeve) is temperature proximate to that of the lower mold. It is preferable that temperature of the lower mold is pertinently changed in accordance with a state of warp of planar glass after press-molding (after correcting warp in the case of correcting warp). For example, when finished planar glass is provided with warp in a recessed shape, by dropping temperature of the lower mold, the viscosity of the glass is reduced and correction of warp at the successive step can be carried out properly. Conversely, in the case of warp in a projected shape, by elevating temperature of the lower mold and increasing the viscosity of the glass in correcting the warp, the warp can be corrected properly.

However, it is pertinent that temperature of the glass after finishing press-molding is temperature higher than the glass transition point and the glass softening point from a view point that there is brought about a state in which the glass after finishing a press-molding operation basically maintains a shape in correspondence with the molding surfaces of the molds even after being removed from the molds and can be deformed by a very small amount by external force. Further, a time period required for press-molding is preferably 2 seconds or shorter, further preferably, 1.8 seconds or shorter. Further, the planar glass constituting an object of the fabricating method of the invention, is a glass molded article suitable for a glass substrate in a shape of a thin plate represented by an information recording medium such as a glass substrate for a magnetic disk and the plate thickness is, for example, equal to or smaller than 4 mm, preferably in a range of 0.5 through 3 mm. Further, it is preferable that the planar glass is constituted by a shape of a disk in consideration of the fact that the planar glass is used as a substrate of an information recording medium, it is pertinent that the diameter is approximately 15 cm or lower, particularly, approximately 10 cm.

According to the pressing step, by pressing to expand the glass material to be molded in outer peripheral directions of the molds, the glass can be molded in a shape of a thin plate. It is preferable to adhere a solid lubricant to the molding surfaces of the molds to thereby promote lubricity with respect to glass in view of capable of easily pressing to expand the glass material to be molded in the outer peripheral directions of the molds. Further, when the glass material to be molded is molten glass and thin planar glass is formed, temperature of molds become higher than that in the case of providing thick planar glass since a larger amount of heat is received from the molten glass. Therefore, it is preferable that the solid lubricant is heat-resistant such that the lubricity is not lost even in a high temperature region. Although the heat-resistant solid lubricant is not particularly limited so far as the lubricant is excellent in heat resistance, for example, boron nitride (BN) is preferable. Further, there may be used a glass material to be molded having high melting temperature to provide planar glass excellent in mechanical strength even in the case of an extremely thin planar glass. In that case, temperature of molds becomes significantly high and accordingly, very high heat resistance is required for the solid lubricant. Even in such a case, highly heat-resistant solid lubricant powder such as BN powder is preferably used. By using a pulverized heat-resistant solid lubricant, the solid lubricant power can easily be adhered uniformly to molding surfaces and an extra portion thereof can easily be removed. The solid lubricant is operated as a mold-releasing agent.

Further, a material of molds can be used so far as the material is provided with heat resistance, graphite, tungsten alloy, nitride, carbide, heat-resistant metal or the like is used therefor and cast iron is particularly preferable since cast iron is excellent in strength and durability.

### Taking Out Step

In the taking out step, the upper mold is removed from the planar glass after press-molding, thereafter, the planar glass on the molding surface of the lower mold is taken out from the molding surface of the lower mold. Preferably, after removing the upper mold from the planar glass, the planar glass is taken out from the molding surface of the lower mold after the planar glass on the molding surface of the lower mold has been cooled to a state in which the planar glass is not deformed by external force. Whether “a state of not being deformed by external force” is constituted can be determined with whether temperature of the surface of the planar glass becomes equal to or lower than (glass transition point +20° C.) as a criterion according to the invention specified by respective claims of the application. Preferably, temperature of the surface of the planar glass is equal to or lower than (glass transition point +10° C.), further preferably, the temperature of the surface of the planar glass is equal to or lower than the glass transition point. Particularly, it is preferable that the glass is removed in a state in which the temperature of the surface of the planar glass becomes equal to or lower than (glass transition point −10° C.). Further, the temperature of the surface of the glass can be measured by a radiation thermometer. According to the method of the invention, it is preferable that both of temperature of an upper face of the planar glass on the molding surface of the lower mold (face molded by upper mold) and temperature of a lower face thereof (face molded by lower mold), are dropped to be equal to or lower than the glass transition point. Cooling in the taking out step is finished before temperature of the planar glass is dropped to the strain point of the glass.

Cooling of the planar glass can be carried out by exposing the face of the planar glass to an atmosphere in a molding apparatus containing the molds or air by removing the upper mold from the planar glass. The atmosphere in the molding apparatus can be air or an inert gas of nitrogen and temperature of the atmosphere needs not to adjust particularly and may be, for example, room temperature. By carrying out the step by air, special gas is not used and accordingly, cooling can be carried out inexpensively and simply. Although in the taking out step, the face molded by the upper mold is exposed to the atmosphere or in the atmosphere and there is produced a temperature difference between the face and a face thereof in contact with the lower mold, according to the invention, even when there is such a temperature difference, warp after taking out the glass can be reduced.

In the taking out step, preferably, in parallel with cooling, warp can be corrected by exerting external force to the planar glass. Correction of warp is carried out, for example, in a state in which temperature of the planar glass is higher than the glass transition point of the glass. By correcting warp, warp of the glass caused after pressing can be corrected and the glass can be flattened, further, by the cooling step, warp caused after the taking out step can be removed and accordingly, an amount of a total of warp can further be reduced.

According to the glass member after press-molding, quantities of heat taken away via the respective molds differ from each other, which causes to warp to bend opposed principal faces of the glass member. It is a warp correcting step of the thin planar glass to reduce and remove the warp. As methods of correcting the warp, there are, for example, a method of depriving heat by blowing air to either of an upper face and a lower face having higher temperature in the thin planar glass after press-molding and a method of returnig the glass into a flat shape by external force by pressing the glass member after press-molding by a pair of flat bases (hereinafter, referred to as warp correcting press). When the glass member is pressed by the pair of flat bases, as the pair of flat bases, there may be used the upper mold and the lower mold used in press-molding. It is preferable that the viscosity of the glass in the warp correcting step is a value by which the shape of the glass provided by press-molding is maintained when external force is not exerted thereto and the glass is deformed by a very small amount when the external force is exerted thereto. Temperature of the flat bases used in warp correction preferably falls in a range of 400 through 650° C. Because when the temperature is less than 400° C., the defect is caused in the glass and when the temperature exceeds 600° C., the glass sticks to the bases. It is preferable that the temperature is lower than temperature of the glass by 250 through 20° C. and higher than temperature of the molds used in molding press by 50 through 200° C. This is for preventing to cause crack in the warp correcting step since temperature and the viscosity of the glass are lowered from those in press-molding.

Although according to press-molding, the glass material to be molded such as molten glass is molded into a predetermined shape in correspondence with inner molding surfaces of the molds, the warp correction press is carried out not from the stand point of shaping the thin planar glass provided by press-molding but for removing (or reducing) warp of the thin planar glass shaped by press-molding and forming the thin planar glass into a flat or substantially shape. According to preferable warp correcting press, warp of the thin planar glass is corrected by cooling and hardening the thin planar glass which is brought into the flat state between the upper mold and the lower mold, by a pair of flat bases (or upper mold and lower mold) having temperature lower than temperature of the glass. It is preferable to carry out warp correcting press in a state in which temperature of inside of the thin planar glass is higher than the glass transition point. When warp correcting press is carried out in the state in which the temperature of glass is equal to or lower than the glass transition point, fissure or crack tends to cause in the thin planar glass since the thin planar is excessively hard. Meanwhile, when the thin glass is excessively soft, the shape of the thin planar glass is changed by warp correcting press, which is not preferable and accordingly, an upper limit of temperature for carrying out warp correcting press is determined from the stand point. Further, a number of times of pressing for warp correction is not limited to one but the pressing operation can be carried out by a number of times of two or more as necessary.

### Cooling Step

In the cooling step, the planar glass cooled preferably is taken out from the molding surface of the lower mold in the taking out step and is cooled to temperature lower than the strain point of the glass. In the taking out step, the press-molded planar glass is preferably applied with the above-described warp correcting press, cooled to a state in which the glass is not deformed by exerting external force and thereafter taken out from the lower mold. The planar glass taken out is exposed to, for example, the atmosphere in a state in which the glass is held by an insulating member and is cooled to temperature lower than the strain point in the cooling step. It is preferable that the glass is cooled comparatively rapidly and it is preferable that the glass taken out from the lower mold is exposed to an atmosphere of temperature lower than predetermined temperature. By rapidly cooling the glass, the glass can be cooled to temperature lower than the strain point before enlarging warp. It is pertinent that temperature of the glass is dropped rapidly to temperature lower than the strain point within 180 seconds, preferably, 60 seconds. An atmosphere at which the glass is exposed may be the atmosphere or may be an atmosphere filled with other kind of gas. However, it is preferable that the atmosphere is provided with a heat capacity sufficiently larger than a heat capacity of the molded glass. When the glass is exposed to the atmosphere, it is not necessary to prepare an atmosphere other than air and it is not necessary to adjust temperature of the atmosphere, which is simple.

However, when cooling gas is blown to cool the glass immediately after taking out thereof, temperature of a portion of the glass blown with the cooling gas is extremely dropped and the temperature difference between the two main surfaces of the glass is increased, which is not preferable in view of reducing warp. Further, when the gas is blown thereto immediately after taking out thereof, the glass may be delicately deformed by pressure of the gas, which is not preferable. When there is not temperature difference between the two main surfaces of the glass taken out from the lower mold, the cooling rate may be small, however, it is difficult to dispense with the temperature difference in the glass immediately after having been taken out therefrom. Accordingly, in view of reducing warp, the glass taken out from the lower mold is cooled to temperature lower than the strain point at which warp is difficult to cause as fast as possible. Therefore, it is preferable that the cooling rate in the cooling step (cooling rate from temperature of taking out the glass to the strain point), is made as large as possible within a range of not destructing the glass by rapid temperature change.

The cooling step may be carried out by dipping the planar glass in a liquid having temperature lower than the strain point of the glass other than by the method of exposing the glass in an atmosphere or in the atmosphere. Here, it is preferable that the liquid is provided with heat capacity sufficiently larger than the heat capacity of the molded glass. It is pertinent that the liquid is of a liquid substance which does not react with the glass, for example, the glass may be dipped in a liquid substance melted with a low melting point metal having a melting point lower than the strain point of the glass such as tin (melting point: 232° C.).

It is preferable that the cooling step as well as the successive annealing step are carried out by vertically placing the planar glass. Here, the vertically-placed state signifies a state in which a normal line at a central portion of the principal face of the thin planar glass is directed substantially in the horizontal direction. The planar glass can be placed vertically in a state in which the planar glass taken out from the lower mold is supported by an insulating member having a structure capable of placing the planar glass vertically. Depending on temperature of the supporting plate, an increase in warp of the glass can be reduced.

### Annealing Step

In the annealing step, the planar glass cooled by the cooling step is annealed. The glass cooled to temperature lower than the strain point is heated again and annealed. A temperature condition of annealing can be a condition which is normally adopted. The annealing step as well as the cooling step are preferably carried out by placing the planar glass vertically. The glass can be placed vertically in a state in which the glass is not deformed by exerting external force, further, warp can be reduced by annealing the glass in the vertically-placed state. Further, warp of the glass is caused at the strain point of the glass or higher and therefore, when the vertically-placed state of the glass is maintained at least during a time period in which temperature of the glass is equal to or higher than the strain point in the annealing step, the above-described effect can be achieved. Although means for bringing about the vertically-placed state is not particularly restricted, the planar glass can be pinched to support by heat-resistant supporters on both sides thereof or a plurality of sheets of laminated planar glass can be pinched and supported by the above-described supporters.

The glass may be placed vertically simultaneously with or immediately after taking out the glass from the molded molds or after the cooling step. When the glass needs to cool to lower temperature for carrying out the vertically placing operation after the cooling step, the glass may be cooled rapidly by blowing gas. It is preferable to bring the glass into the vertically-placed state prior to bringing about the state in which temperature of the glass is higher than the strain point.

The thin planar glass which has been brought into the vertically-placed state, is set to a member of holding the glass in, for example, vertically-placed state and is transferred to an annealing furnace by a transfer apparatus. Since the glass is cooled once to temperature lower than the strain point, the glass is not heated rapidly and is moved to a region set with annealing temperature via a region set with temperature lower than the annealing temperature. The annealed glass is gradually cooled to room temperature.

In producing a number of sheets of glass, it is preferable to anneal the glass by introducing a plurality of the members set with a plurality of sheets of glass for holding the vertically-placed state into an annealing furnace. The annealed glass is lapped and polished and fabricated as a substrate. In the procedure, the glass is pertinently cleaned. Further, in the procedure, the glass may be subjected to a chemically strengthening processing by ion exchange or crystallizing processing.

According to the first fabricating method of the invention, the planar glass product is continuously fabricated by repeating a series of steps from the supplying step to the annealing step. In this case, the lower mold after taken out of the planar glass in the cooling step, is recycled to the supplying step after adjusting the lower mold to predetermined temperature. It is sufficient to lower temperature of the lower mold to a vicinity of the glass transition point until the glass is taken out from the lower mold and accordingly, a time period required for supplying the lower mold taken out of the glass to the glass material to be molded and adjusting the lower mold to temperature in starting the pressing operation, is short and the glass molded article having small warp can be fabricated with excellent productivity.

The lower mold is designed to successively undergo the supplying step of the glass material to be molded, the pressing step, (warp correcting step as necessary) and the step of taking out the molded product in the taking out step. For example, although it is preferable that a plurality of pieces of lower molds are arranged on a circumference of a turn table and the turn table is rotated such that the lower molds undergo the respective steps, the lower molds may be designed to move in a linear direction. In this way, the series of steps can be carried out using a plurality of lower molds and moving and circulating respectives of the plurality of lower molds successively to positions for carrying out the series of steps. However, since the plurality of lower molds are circulated to use and therefore, in comparison with a method of using one lower mold, shortening of a time period of adjusting temperature of the lower mold becomes more important in view of promoting the productivity.

Further, a number of lower molds simultaneously subjected to the respective step may be single or plural. Meanwhile, the upper molds are arranged to be opposed to the lower molds disposed in the step of press-molding. Therefore, a number of the upper molds needs to be at least the same as the number of the lower molds used in a single press-molding operation, however, the lower molds having a larger number may be provided. Further, a single piece of the upper mold may be used when temperature thereof can be controlled in a short period of time such that heat transferred from molten glass to the upper mold after press-molding is removed and temperature of the upper mold becomes temperature pertinent for molding.

As described above, it is necessary that temperatures of respective molding surfaces of the upper mold and the lower mold are adjusted to predetermined temperatures in starting the press-molding operation. Here, the predetermined temperatures with regard to the upper mold and the lower mold signify temperatures suitable for molding a glass material into a shape of a thin plate. Such temperatures are temperatures pertinently determined by kind of glass, thickness and size of glass plate.

Further, in order to adjust temperatures of molding surfaces of the upper mold and the lower mold to the predetermined temperatures in starting press-molding, with respect to the upper mold and the lower mold, there are carried out means for heating thereof and means for cooling thereof as necessary. As heating means, for example, there are a method of heating the lower mold (upper mold) by arranging a plurality of nichrome heaters at a surrounding thereof, a method of inductively heating the mold comprising a conductive member by making current flow to a coil arranged to surround the lower mold (upper mold) and a method of heating thereof by gas. In the case of arranging a plurality of pieces of lower molds (upper molds), when the respective lower molds (upper molds) are heated by arranging the nichrome heaters therearound, owing to a dispersion in temperature among the respective nichrome heaters, it is difficult to uniformly heat the respective lower molds (upper molds) and accordingly, the method by induction heating capable of uniformly heating the molds is preferable. According to the induction heating, the respective lower molds (upper molds) can be heated by one coil and therefore, there poses no problem of the dispersion in temperature of a heat source and the molds can be heated uniformly by making constant distances between the coil and the respective lower molds (upper molds). Here, it is preferable that current which is made to flow to the coil in induction heating is high frequency current. In the case of low frequency current, the apparatus becomes large-scaled and noise may pose a problem since the low frequency falls in an audible range of person. Meanwhile, in the case of a single piece of lower mold (upper mold), there poses no problem of dispersion in temperature among the respective nichrome heaters and accordingly, there can be adopted a method of heating the lower mold (upper mold) by arranging the nichrome heaters therearound.

Temperature of the molds subjected to press-molding is more elevated than that before press-molding. In order to continuously form the glass, it is necessary to cool the molds until successive press-molding and to form any of the molded products under an equivalent temperature condition. Therefore, cooling means is needed as well as the heating means. As cooling means, there can be adopted a method of circulating water or air in a hollow portion of the mold, a method of blowing a liquid such as water to an inner face of the hollow portion of the mold to vaporize and so on. According to the method of blowing a liquid to vaporize, the molds can be cooled by the vaporization heat of the liquid and accordingly, cooling effect can be achieved by an amount of the liquid smaller than that in the method of circulating the method. Therefore, the method of utilizing the vaporization heat of water is preferable not only in view of the cooling effect but also in view of capable of further downsizing the cooling apparatus. Further, for example, when time is taken in cooling the upper molds and the upper molds cannot be cooled to predetermined temperature after molding until successive molding, a plurality of upper molds may be prepared, when any one of the upper molds carries out press-molding, other upper molds may be cooled and the cooled upper molds may successively subjected to press-molding.

In finishing press-molding, temperature of the planar glass is higher than temperature of the molds and at the time point, the thin planar glass and the molds are not brought into a thermally balanced state. However, as described above, since the molds are maintained previously at predetermined temperature, the thin planar glass provided by cooling after molding, is constituted by a constant shape by which quality in warp is constant and a shape easy to lap and polish. Further, the thin planar glass and molds need not to cool to reach the thermally balanced state and accordingly, the molding time period can be shortened.

A second fabricating method of a glass molded article according to the invention, is a method of providing a planar glass molded article by pressing a glass material to be molded by using molds at least comprising an upper mold and a lower mold, taking out the provided planar glass from the molds and annealing the planar glass and the method is characterized in that the annealing operation is executed by placing the planar glass vertically.

Although the first fabricating method of a glass molded article according to the invention, is limited in the cooling condition, the second fabricating method of a glass molded article according to the invention is characterized only in executing the annealing operation of the planar glass by vertically placing the planar glass. The steps until the annealing step are not particularly limited. Even when temperature of the planar glass becomes equal to or higher than the strain point in the annealing operation, by placing the planar glass vertically, in comparison with annealing the planar glass in the horizontal state, an amount of warp can be reduced.

Here, the vertically-placed state signifies a state in which a normal line at a central portion of a principal face of the planar glass is directed substantially in the horizontal direction.

It is preferable to place the planar glass vertically when temperature thereof is lower than the strain point of the glass. When the glass is heated to a temperature range equal to or higher than the strain point causing warp of the glass, warp can be reduced since there already is brought about the vertically-placed state which is difficult to cause warp.

It is preferable that annealing is carried out by transferring planar glass in a state of being placed vertically on transfer means in an annealing furnace. The planar glass is annealed during a time period of being transferred in the annealing furnace and therefore, a number of sheets of the planar glass are annealed with excellent productivity and by placing the planar glass vertically, warp of glass caused in annealing can be reduced.

The first fabricating method of a glass molded article according to the invention can be carried out by using a fabricating apparatus having, for example, molds each comprising at least an upper mold and a lower mold for pressing a glass material to be molded into planar glass, an annealing furnace for annealing the planar glass and a transfer unit for transferring the planar glass to the annealing furnace after temperature of the planar glass removed from the molds becomes lower than the strain point of the glass. According to the apparatus, it is preferable that the transfer unit is means for transferring the planar glass in the vertically-placed state.

The second fabricating method of a glass molded article according to the invention can be carried out by using a fabricating apparatus having molds each comprising at least an upper mold and a lower mold for pressing a glass material to be molded into planar glass, an annealing furnace for annealing the planar glass and a transfer unit for transferring the planar glass in the vertically-placed state.

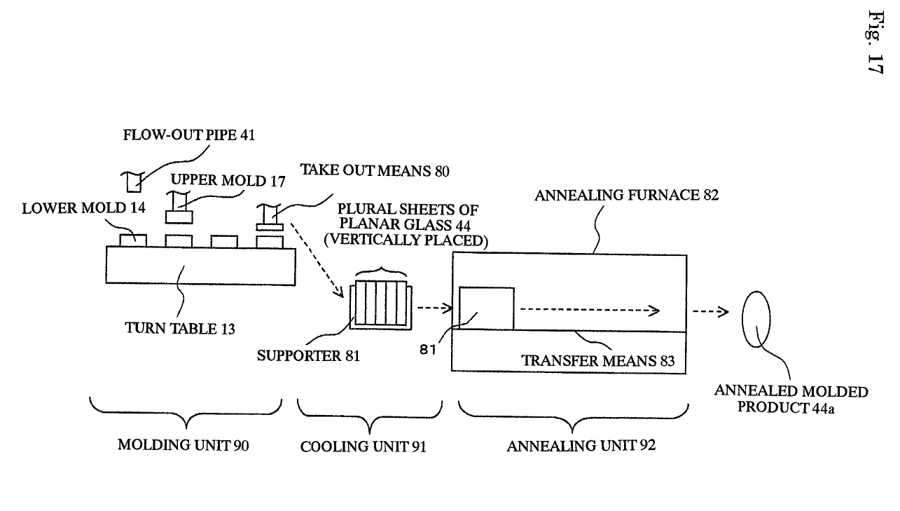

FIG. 17 shows an outline view of a fabricating apparatus of a planar glass molded article having molds, an annealing furnace and a transfer unit, mentioned above. The apparatus comprises a molding unit 90 arranged with a plurality of lower molds 14 above a turn table 13 and having a flow-out pipe 41, an upper mold 17 and planar glass taking out means 80 at positions opposed to the lower molds in accordance with the taking out step, a cooling unit 91 comprising a supporter 81 for holding to cool and/or transfer planar glass 44 taken out from the molding surface of the lower mold by the taking out means 80 (the support 81 preferably holds a plurality of sheets of the planar glass 44), and annealing unit 92 comprising an annealing furnace 82 and transfer means 83 for moving (transferring) the supporter 81 holding the planer glass 44 in the annealing furnace 82.

The planar glass molded article is fabricated by using the apparatus as follows.

Molten glass (not illustrated) is supplied from the flow-out pipe 41 to the molding surface of the lower mold 14. Before supplying the molten glass, a mold-releasing agent, for example, boron nitride powder is coated on the molding surface of the lower mold (a coating mechanism is not illustrated). The lower mold 14 supplied with the molten glass is moved to a press position by a mechanism of the turn table 13 and the glass is press-molded by the upper mold and the lower mold. After molding, the upper mold is removed from the glass and the molded planar glass is moved to a taking out position by the mechanism of the turn table. The planar glass is taken out from the lower mold which reaches the taking out position by the taking out means 80 and is transferred to the cooling unit. A series of steps of coating the mold-releasing agent to taking out the planar glass is carried out by the molding unit 90. In the cooling unit, the planar glass is cooled to temperature lower than the strain point of the glass. As cooling means, there can be adopted any of the above-described methods or a combination thereof (natural cooling, blowing cooling gas, dipping glass to a liquid). In the case of natural cooling, there may be provided a portion of storing the planar glass in the cooling unit such that the planar glass is exposed for a predetermined time period in the atmosphere, or a mechanism of adjusting transfer speed such that the time period of exposing the planar glass in the atmosphere becomes predetermined time period in the taking out transfer, or a mechanism of using both of the storing portion and the transfer means the transfer speed of which is adjusted. The glass 44 taken out is transferred to the annealing furnace by being brought into the vertically-placed state by the supporter 81. Further, the glass is annealed during a time period of transferring in the annealing furnace 82 and the annealed planar glass is taken out from an outlet of the furnace.

As has been explained above, when warp of the thin planar glass is large, although the warp of the glass is temporarily corrected by applying pressure to the thin planar glass in lapping and polishing, when the pressure is released, the glass is warped again. Therefore, the warp of the glass remains permanently and accordingly, the fabrication needs to carry out while delicately adjusting applied pressure. However, according to the invention, the warp of the thin planar glass has been reduced and therefore, an amount of deforming the glass by the pressure exerted in the lapping and polishing is reduced and therefore, in comparison with the conventional method, pressure may not be adjusted finely and lapping and polishing time period can be shortened.

According to the planar glass finished by undergoing the press-molding and the taking out steps (including warp correcting press), the cooling step and the annealing step in the vertically-placed state by the fabricating method of the invention, there is a case in which the warp is completely removed and a case in which a small amount of the warp remains. Even when the small amount of warp remains, when the warp can be removed by mechanical lapping and polishing, the planar glass may be regarded as a pressed finished product in which warp remains.

When the warped glass substrate is simply subjected to normal lapping and polishing, normally, the finished product still warps. Therefore, in lapping and polishing the warped pressed product, a devise is needed. In order to realize excellent polishing method, in polishing, the pressed product may be polished by restraining bending of the pressed product from being deformed by load of a lapping machine of polishing. Specifically, the load of the lapping machine is gradually increased by elapse of time from start of lapping, firstly, a flat glass substrate is molded and thereafter, the pressed product may be polished by further increasing the load such that the plate thickness becomes a predetermined dimension. Further, as other method of restraining deformation of bending of a pressed product, the shape of the pressed product is not molded in a simple circular disk shape but a pressure receiving portion for supporting pressure of the lapping machine may be molded at a peripheral portion of the press product at the stage of press-molding. In the case of such a shape, the pressure of the lapping machine is received by the press receiving portion and accordingly, deformation of the bent portion can easily be restrained. Further, the glass product having such a pressure receiving portion is included in thin planar glass.

Further, the invention of lapping and polishing a warped glass substrate to be flat in this way is applicable to a pressed product provided by a method described in a press method described in Japanese Patent Laid-Open No. 105458/1993 or Japanese Patent Laid-Open No. 133121/1995.

The planar glass provided by the above-described fabricating method becomes, for example, glass substrate for an information recording medium after undergoing mechanical working of lapping and polishing. Steps of lapping and polishing in that case comprises, by gross classification, (1) rough working (rough polishing), (2) sand applying (fine polishing, lapping), (3) first polishing (polishing) and (4) second polishing (final polishing, polishing). Depending on cases, (1) rough working (rough polishing) may be omitted.

Further, the glass substrate for an information recording medium constitutes a magnetic recording medium by successively laminating a matrix layer, a magnetic layer, a protective layer and a lubricating layer. Here, as materials of the glass substrate of the magnetic recording medium, for example, there are pointed out aluminosilicate glass, soda lime glass, soda aluminosilicate glass, alminoborosilicate glass, borosilicate glass, quartz glass, chainsilicate glass and glass ceramics such as crystallized glass. Further, preferably, there is used glass having the following compositions.

(1) Crystallized glass 1

Crystallized glass including, in weight %, 60 through 87% of SiO₂, 5 through 20% of Li₂O, 0 through 5% of Na₂O, 0 through 10% of K₂O, a total of 0.5 through 10% of Na₂O and K₂O, 0.5 through 7.5% of MgO, 0 through 9.5% of CaO, 0 through 15% of SrO, 0 through 13% of BaO, 0 through 13% of ZnO, 0 through 10% of B₂O₃, 0 through 10% of Al₂O₃, 0.5 through 8% of P₂O₅, 0 through 5% of TiO₂, 0 through 3% of ZrO₂, 0 through 3% of SnO₂, a total of 0 through 2% of As₂O₃ and Sb₂O₃, and a total of 0 through 5% of a total amount in F of a fluoride of a metal element of one kind or more of the above-mentioned metal oxides, including, depending on cases as a coloring component, 0 through 5% of at least one kind selected from the group consisting of V₂O₅, CuO, MnO₂, Cr₂O₃, CoO, MoO₃, NiO, Fe₂O₃, TeO₂, CeO₂, Pr₂O₃, Nd₂O₃, and Er₂O₃, including, as main crystal, lithium disilicate, depending on cases, α-cristobalite, α-quartz, lithium monosilicate, and β-spodumene and having a size of a crystal particle equal to or smaller than 3.0 μm.

(2) Crystallized glass 2

Crystallized glass including, in weight %, 45 through 75% of SiO₂, 4 through 30% of Cao, 2 through 15% of Na₂O, 0 through 20% of K₂O, 0 through 7% of Al₂O₃, 0 through 2% of MgO, 0 through 2% of ZnO, 0 through 2% of SnO₂, 0 through 1% of Sb₂O₃, 0 through 6% of B₂O₃, 0 through 12% of ZrO₂, 0 through 3% of Li₂O, and 3 through 12% of a total amount in F of a fluoride of one kind or more of metal element of the above-mentioned metal oxides, including, depending on cases as a coloring component, Cr₂O₃ and Co₃O₄, including, as main crystal, canacite or potassium fluorolihitelite and having a size of a crystal particle equal to or smaller than 1.0 μm.

(3) Crystallized glass 3

Crystallized glass including:

SiO₂: 35-65 molar %

Al₂O₃: 5-25 molar %

MgO: 10-40 molar %

TiO₂: 5-15 molar %,

a total of the above-mentioned composition is equal to or larger than at least 93 molar % and having a composition in which a molar ratio (Al₂O₃/MgO) is less than 0.5. The crystallized glass is preferably provided with main crystal phase of enstatite and/or solid solution thereof.

(4) Crystallized glass 4

Crystallized glass including SiO₂: 42-65 molar %, Al₂O₃: 11-25 molar %, MgO: 15-33 molar %, and TiO₂: 5.5-13 molar % and having a main crystal phase of α-quartz solid solution and enstatite and/or enstatite solid solution.

Crystallized glass including SiO₂: 42-65 molar %, Al₂O₃: 11-25 molar %, MgO: 15-33 molar %, and TiO₂: 5.5-13 molar %, including α-quartz solid solution and enstatite and/or enstatite solid solution in which a total of α-quarts solid solution, enstatite and enstatite solid solution is equal to or larger than 50 weight %.

Crystallized glass including SiO₂: 42-65 molar %, Al₂O₃: 11-25 molar %, MgO: 15-33 molar %, and TiO₂: 5.5-13 molar %, having the main crystal phase including quartz system crystal and enstatite and/or enstatite solid solution in which there is observed a diffraction pattern substantially equivalent to a diffraction pattern particular to quartz in X-ray diffraction pattern and having a specific weight equal to or larger than 2.9.

Crystallized glass including SiO2: 42-65 molar %, Al₂O₃: 11-25 molar %, MgO: 15-33 molar %, and TiO₂: 5.5-13 molar % in which a crystal phase thereof includes quartz system crystal and enstatite and/or enstatite solid solution in which there is observed a diffraction pattern substantially equivalent to a diffraction pattern particular to quartz in X-ray diffraction pattern, a total of quartz system crystal, enstatite and enstatite solid solution is equal to or larger than 50 weight % and a specific weight thereof is equal to or larger than 2.9.

(5) Glass 5

Glass including, in weight %, 62 through 75% of SiO₂, 4 through 18% of Al₂O₃, 0 through 15% of ZrO₂, 3 through 12% of Li₂O, and 3 through 13% of Na₂O. Glass for chemical strengthening including, in weight %, 62 through 75% of SiO₂, 5 through 15% of Al₂O₃, 4 through 10% of Li₂O, 4 through 12% of Na₂O, and 5.5 through 15% of ZrO₂ in which a weight ratio of Na₂O/ZrO₂ is 0.5 through 2.0 and a weight ratio of Al₂O₃/ZrO₂ is 0.4 through 2.5.

(6) Glass 6

Glass including, as glass components, 0.1 through 30 molar % of TiO₂, 1 through 45 molar % of CaO, 5 through 40 molar % of a total of MgO and CaO, 3 through 30 molar % of a total of Na₂O and Li₂O, less than 15 molar % of Al₂O₃, and 35 through 65molar % of SiO₂, or glass for chemical strengthening comprising the glass. Glass including a transition metal oxide in place of a portion or a total of TiO₂ constituting the glass component of the glass.

Such a glass substrate can be subjected to a chemical strengthening processing by a low temperature ion exchange method at its surface with an object of promoting impact resistance or vibration resistance. Here, the chemical strengthening method is not particularly limited so far as the method is a conventionally publicly-known chemical strengthening method, for example, low temperature type chemical strengthening for carrying out ion exchange in a region not exceeding the transition temperature is preferable in view of the glass transition point. As alkaline molten salt used for chemical strengthening, there is pointed out potassium nitrate, sodium nitrate or nitrate mixed with these.

As the matrix layer, there is pointed out a matrix layer comprising a material of at least one kind or more selected from nonmagnetic metals of, for example, Cr, Mo, Ta, Ti, W, V, B, Al and the like. In the case of a magnetic layer whose major component is Co, a simple substance of Cr or a Cr alloy is preferable in view of promoting magnetic properties. Further, the matrix layer is not limited to a single layer but can be constituted by a structure of a plurality of layers by laminating the same or different kinds of layers. For example, there are pointed out matrix layers of multiple layers of Cr/Cr, Cr/CrMo, Cr/CrV, CrV/CrV, Al/Cr/CrMo, Al/Cr/Cr, Al/Cr/CrV and Al/CrV/CrV.

As the magnetic layer, for example, there are pointed out magnetic thin films of CoPt, CoCr, CoNi, CoNiCr, CoCrTa, CoPtCr, CoNiPt, CoNiCrPt, CoNiCrTa, CoCrTaPt and CoCrPtSiO whose major component is Co. The magnetic layer may be constructed by a multiple layer constitution (for example, CoPtCr/CrMo/CoPtCr, CoCrTaPt/CrMo/CoCrTaPt) achieving a reduction in noise by dividing a magnetic film by a nonmagnetic film (for example, Cr, CrMo, CrV). As a magnetic layer in correspondence with a magnetoresistive type head (MR head) or a large-sized magnetoresistive type head (GMR head), there is included a Co series alloy including an impurity element selected from Y, Si, rare earth element, Hf, Ge, Sn and Zn or oxides of the impurity elements. Further, the magnetic layer may be granular in a structure in which magnetic particles of Fe, Co, FeCo, CoNiPt or the like are dispersed in a nonmagnetic film comprising a ferrite series, iron-rare earth series, SiO₂, BN other than the above-described. Further, the magnetic layer may be of a recording style of either of an inner face type and a vertical type.

As the protective layer, for example, There is pointed out a Cr film, Cr alloy film, a carbon film, a zirconia film or a silica film. These protective layers can be formed continuously by an inline type sputtering apparatus along with the matrix layer and the magnetic layer. Further, the protective layer may be of a single layer, or may be constructed by a multiple layer constitution comprising the same or different kinds of films. Further, other protective layer may be formed over the protective layer or in place of the protective layer. For example, in place of the above-described protective layer, a silicon oxide (SiO₂) film may be formed by dispersing and coating very small particles of colloidal silica in tetraalcoxelane diluted by a solvent of alcohol species above a Cr film and sintering thereof.

The lubricating layer is formed by, for example, diluting perfluoropolyeter (PFPE) which is a liquid lubricant by a freon species solvent, coating thereof on a surface of a medium by dipping process, spin coating process or spray process and carrying out a heating processing as necessary.

The present disclosure relates to the subject matter contained in Japanese Patent Application No. 2000-69069, filed on Mar. 13, 2000, which is expressly incorporated herein y reference in its entirety.

### Embodiments

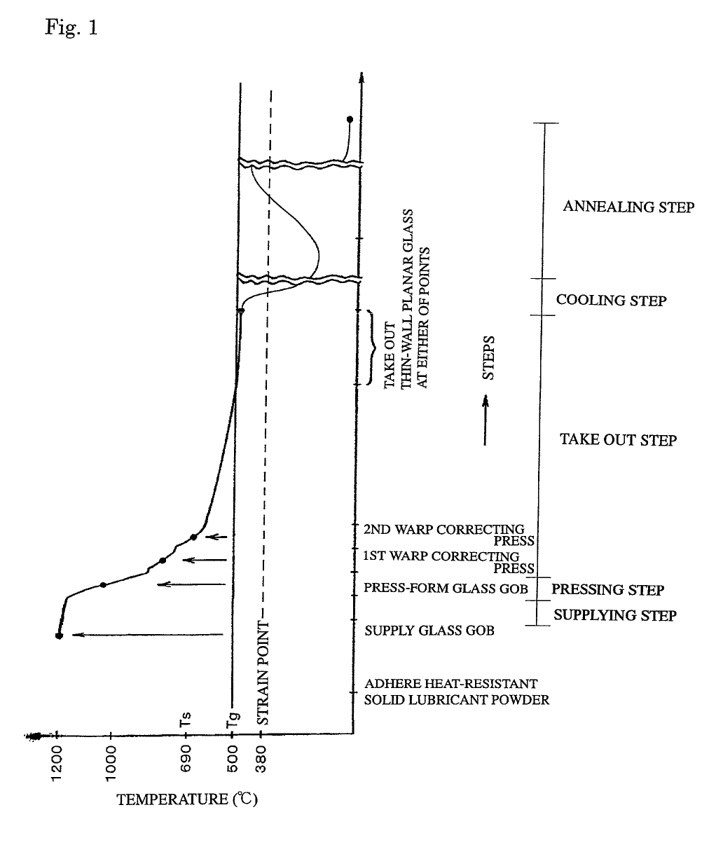

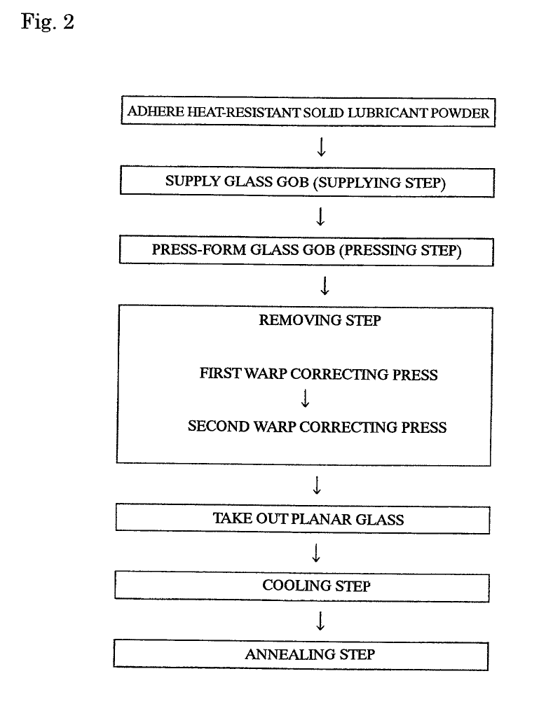

Next, an explanation will be given of the embodiment in reference to the attached drawings as follows. FIG. 1 is an outline diagram showing temperature change of glass starting from raw material glass and reaching planar glass when the glass finishes annealing and FIG. 2 is a step diagram of a fabricating method. Further, time scale of the abscissa is not constant in FIG. 1.

The composition of raw material glass used in the embodiment is as follows. That is, SiO₂ is 63.7, Al₂O₃ is 14, Li₂O is 7, Na₂O is 9, ZrO₂ is 6, and Sb₂O₃ is 0.3 respectively in weight %.

As shown by FIG. 2, according to a fabricating method of the embodiment of the invention, firstly, a heat-resistant solid lubricant powder is adhered to a molding surface of a lower mold. The heat-resistant solid lubricant powder comprises hexagonal BN (boron nitride) powder and is adhered to the molding surface of the lower mold by injection along with gas. By adhering the heat-resistant solid lubricant powder to the molding surface, promotion of removing performance and promotion of elongation of molten glass can be achieved. Next, a pertinent amount of molten glass (1200° C. as shown in FIG. 1) is supplied to the molding surface of the lower mold to thereby constitute glass gob in a shape of a marble rounded by surface tension (supplying step). Next, an upper mold is lowered onto the lower mold and the glass gob is press-molded into thin planar glass by the upper and the lower molds (pressing step). At this occasion, press-molding is carried out in an extremely short period of time of about 1 second and when the thin planar glass (3.0 inch Φ-1.5 mmt) stays in a softened state, that is, when inside of the thin planar glass is equal to or higher than the softening point (Ts) of 690° C. as shown by FIG. 1, the upper mold is elevated and the press-molding is finished. Further, the upper mold subjected to the press-molding is adhered with the heat-resistant solid lubricant powder (hexagonal BN powder) previously on a molding surface thereof similar to the lower mold. Therefore, when the upper mold is detached from the planar glass in the softened state at high temperature, the glass can be prevented from being welded to the upper mold.

Next, after removing the upper mold from the molded glass, there is carried out warp correcting press for correcting a warp rate in parallel with cooling with respect to the planar glass left on the lower mold. In the warp correcting press, there is used a mold having a molding surface similar to that of the upper mold. According to the embodiment, the warp correcting press is carried out twice. As shown by FIG. 1, when the first warp correcting press is carried out, the planar glass is still at temperature equal to or higher than the softening point of 690° C. When the second warp correcting press is carried out to the planar glass, as shown by FIG. 1, the thin planar glass is at temperature between the softening temperature of 690° C. and the transition point (Tg) of 500° C. Cooling of the planar glass is progressed even in the twice warp correcting press and temperature of the planar glass is made equal to or lower than the transition point temperature of 500° C. (taking out step). When temperature equal to or lower than the transition point temperature is reached (however, temperature equal to or higher than the strain point of 380° C.), the planar glass is taken out from the lower mold, exposed to the atmosphere under room temperature in a state in which the planar glass is supported by an insulating member (horizontally-placed) and is rapidly cooled to temperature lower than the strain point (380° C.) of the glass (cooling step). Further, after the glass has been cooled, the glass is brought into a vertically-placed state and annealed by heating the glass in the vertically-placed state gradually to annealing temperature (9 hours, annealing step, 460° C.).

As described above, the cooling step of the invention is carried out, thereafter, there is measured flatnesses of an upper face (principal face on the side molded by the upper mold) and a lower face (principal face on the side molded by the lower mold) annealed in the vertically-placed state, are measured and shown in Table 1. A sample provided by the embodiment is displayed as end sample (vertically-placed annealing).

Other than the sample, flatness is similarly measured with respect to a sample provided without undergoing the annealing step (hot sample at Table 1) and a sample provided by being annealed in a horizontally-placed state (in Table 1, end sample (normal annealing)).

Further, the end sample becomes a substrate after subjected to lapping and polishing as described later.

TABLE 1
Warp of thin planar glass of embodiment (comparison between
the invention and conventional example)
Shape of thin planar glass: 3.0 inch Φ - 1.5 mmt (disk shape)

| | Upper face flatness (μm) | | | Lower face flatness (μm) | | |
|---|---|---|---|---|---|---|
| | | End sample | | | End sample | |
| | Hot | Vertically- | | | Vertically- | |
| | sam- | placed | Normal | Hot | placed | Normal |
| | ple | annealing | annealing | sample | annealing | annealing |
| Max | 24.3 | 26.7 | 40.4 | 25.3 | 29.2 | 41.1 |
| Min | 11.4 | 11.6 | 8.1 | 10.7 | 12.4 | 13.2 |
| Avg | 16.8 | 18.1 | 22.4 | 18.0 | 19.8 | 22.4 |
| 3 Std | 12.0 | 14.1 | 28.2 | 12.6 | 13.7 | 27.0 |
| Avg + | 28.8 | 32.2 | 50.6 | 30.7 | 33.5 | 50.4 |
| 3 Std | | | | | | |

Measuring machine: Roundness measuring machine
std: Standard deviation

In view of a result shown in Table 1, according to the fabricating method of the invention, there can be reduced warp caused after taking out the glass, which is caused by the temperature difference between the face molded by the upper mold and the face molded by the lower mold, which is present in taking out the glass from the lower mold. By carrying out the cooling step, there is achieved an effect of reducing warp and there is achieved an effect of reducing warp by placing the glass vertically, however, by carrying out the cooling step and placing the glass vertically, the warp can be reduced further excellently.

In addition thereto, there is carried out the correcting press for correcting the warp and accordingly, warp caused during a time period from the pressing step until the glass is taken out from the lower mold can also be reduced.

Further, the press-molding is finished when the thin planar glass stays in a softened state, and the molds and the glass are not brought into a thermally balanced state and accordingly, a time period taken by the press-molding is shortened. In addition to shortening of the press time period, the warp correcting press is finished when inside of the thin planar glass is brought into a state higher than the glass transition point, a time period from finishing the press-molding to finishing the warp correcting press is also set to be short and therefore, according to the method, mass production performance of the thin planar glass is promoted. Further, although according to the method, the press time period is short, heat amounts transferred from the thin planar glass to the upper mold and the lower mold are not uniform, the upper mold side and the lower mold side of the thin planar glass are brought into a thermally unbalanced state, the thin planar glass is brought into a state of being warped to some degree, however, the warp is corrected by the warp correcting press and accordingly, the thin planar glass with excellent flatness is fabricated.

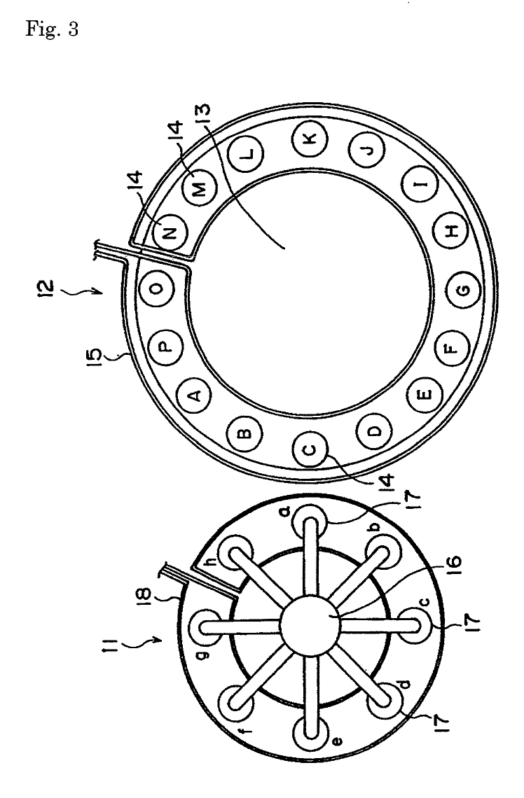

FIG. 3 is a plane view showing a specific example of an upper mold apparatus 11 and a lower mold apparatus 12 used in the above-described method. The lower mold apparatus 12 is constituted by providing 16 pieces of lower molds 14 at equal interval on the same circumference of a turn table 13 rotated by one pitch in a rate of once per 2 seconds centering on a rotating shaft, not illustrate, of a central portion. The lower mold 14 is successively moved to positions from A to P shown in the drawing at each rotation of 1 pitch of the turn table 13. Further, with respect to the lower mold 14, the heat-resistant solid lubricant powder is adhered to the molding surface at position O, the glass gob is supplied thereto at position A, the press-molding is carried out at position C, the first warp correcting press is carried out at position D, the second warp correcting press is carried out at position E and the thin planar glass is taken out therefrom at positions L though N. Further, one high-frequency coil 15 is provided to surround outer sides and inner sides of 16 pieces of the lower molds 14. That is, according to the apparatus, 16 pieces of lower molds 14 are summarizingly subjected to high-frequency induction heating by a single common one of the high-frequency coil 15. Further, the high-frequency coil 15 is arranged to surround the outer sides and inner sides of the lower molds arranged on the circumference such that distances between the lower molds and the coil become constant in order to heat the respective lower molds at the same temperature. Thereby, 16 pieces of the lower molds 14 can uniformly be heated. Further, by rotating 16 pieces of the lower molds 14, positional relationships between 16 pieces of the lower molds 14 and the high-frequency coil 15 become uniform and therefore, 16 pieces of the lower molds 14 can be heated further uniformly. Therefore, when the mold is heated by high-frequency induction heating, there is not caused a partial temperature difference in a single one of the mold and therefore, partial elongation failure of glass and welding of glass to molds can be prevented. Further, a total of the molds can be controlled to desired temperature and the thin planar glass with the same quality can be mass-produced.

The upper mold apparatus 11 is constituted such that the upper molds 17 are attached to front end portions of respective legs of a rotating unit 16 in a shape of octopal legs and 8 pieces of the upper molds 17 are rotated integrally with the rotating unit 16 to positions a though h pitch by pitch at a rate of once per 2 seconds similar to the turn table 13. The upper molds 17 are also heated by high-frequency induction heating. In this case, it is preferable that one high-frequency coil 18 is provided to surround inner sides and outer sides of 8 pieces of the upper molds 17 and 8 pieces of the upper molds 17 are summarizingly subjected to high-frequency induction heating by the high-frequency coil 18. Further, the heat-resistant solid lubricant powder is adhered to the molding surface of the upper mold 17 and can be adhered thereto at any position of the upper mold 17 other than a position thereof subjected to pressing and can be adhered there to at, for example, position e. Further, the upper mold 17 is disposed above the lower mold 14 at position C (shifted to the left side for convenience of illustration in the drawing), at position a right counter to position e and subjected to press-molding. Therefore, according to the apparatus, the respective upper mold 17 is subjected to press-molding when the upper mold 17 is rotated to position a, that is, by a rate of once per 8 times of press-molding, the same upper mold is used for press-molding after a period of time and therefore, abnormal heating of the upper mold 17 can be prevented. That is, temperature of the upper mold 17 is elevated by receiving heat from the glass gob when the upper mold 17 is subjected to press-molding and when the operation is repeated continuously, there is brought about an abnormally heated state and there poses a problem of pasting the glass to the molding surface, however, according to the apparatus, the same upper mold is used after a time interval by the rate of once per 8 times of press-molding and accordingly, the upper mold 17 is not brought into the abnormally heated state and maintained at the predetermined temperature controlled by the high-frequency induction heating and pasting of the glass can be prevented.

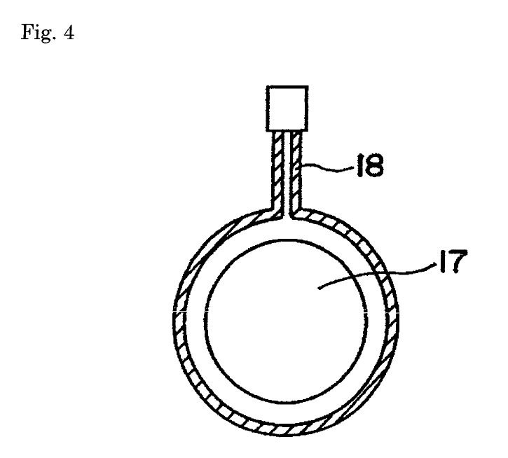

Further, it is preferable that the high-frequency coil 18 of the upper mold apparatus 11 and the high-frequency coil 15 of the lower mold apparatus 12 are both cooled by water and temperatures of the high-frequency coils are prevented from becoming high by heat radiated from the molds. Further, for example, when a number of the upper molds is single, as shown by FIG. 4, the upper mold 17 can be heated uniformly by arranging the coil 18 such that the distance between the upper mold 17 and the coil 18 becomes constant. Further, when the upper mold is single as shown by FIG. 4, there may be adopted a method of heating the upper mold by arranging a nichrome heater similarly at a surrounding of the upper mold in place of the coil 18.

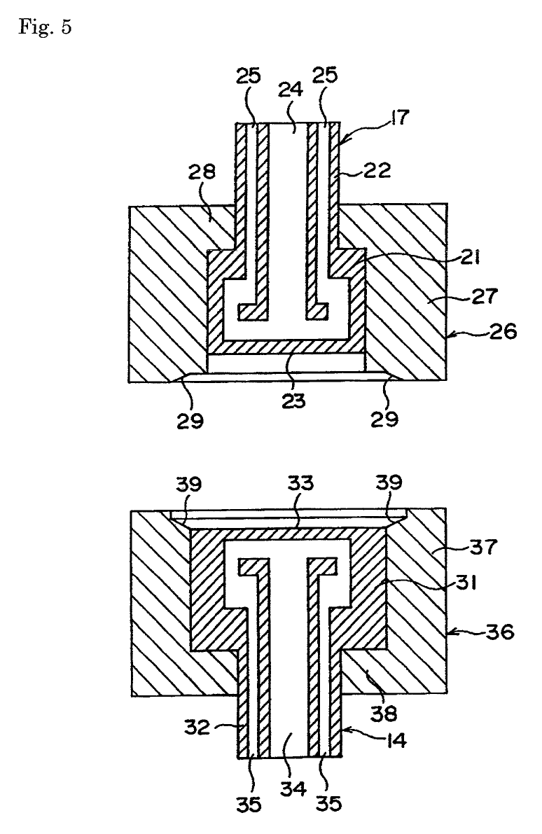

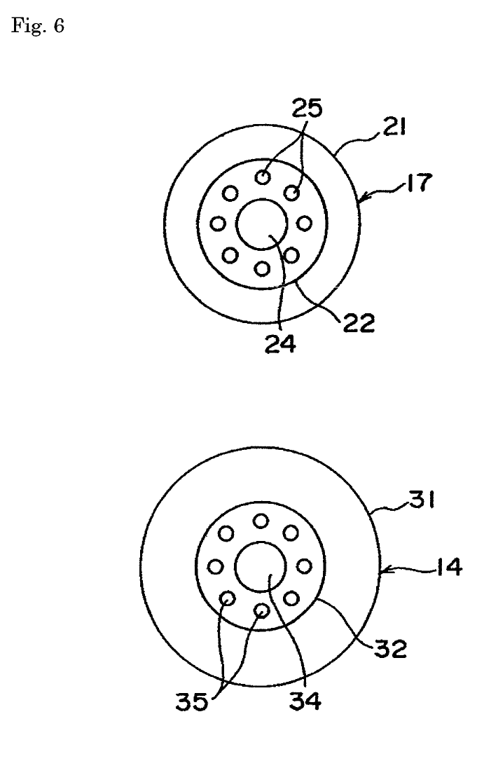

Although various structures of the upper mold 17 and the lower mold 14 can be used, a specific example is shown in FIG. 5. The upper mold 17 is constituted by an upper mold main body 21 in a cylindrical shape and a support rod 22 formed at a central portion of the upper face of the upper mold main body 21 for supporting the upper mold main body 21 and a flat lower face of the upper mold main body 21 constitutes a press surface (molding surface) 23. Further, by moving the support rod 22 upwardly and downwardly by driving means, not illustrated, the upper mold 17 is moved upwardly and downwardly. Further, there is formed a hollow portion 24 opened to an upper face of the support rod 22 at central portions of the upper mold main body 21 and the support rod 22, further, as shown by the plane view of FIG. 6, there are formed 8 pieces of discharge holes 25 communicating with the hollow portion 24 at an inward portion of the hollow portion 24 and opened to the upper face of the support rod 22 at an upper mold portion at a surrounding of the hollow portion 24. Here, when water is sprayed to the hollow portion 24 along with air, the upper mold 17 can be cooled by using the vaporization heat of water. Vaporized water is discharged from the discharge holes 25. The vaporization heat of water per unit volume is larger than the specific heat and therefore, according to a cooling method utilizing the vaporization heat, the upper mold 17 can be cooled more efficiently than by the method of circulating water as a cooling medium with no need of a large facility.

The upper mold 17 is provided with a cylindrical mold 26 to surround the upper mold 17 and the cylindrical mold 26 is constituted by a cylindrical mold main body 27 in a cylindrical shape and a flange portion 28 in a shape of a circular ring formed by projecting to an inner side of an upper end portion of the cylindrical mold main body 27. Here, an inner peripheral face of a lower face portion the cylindrical mold main body 27 is larger than other portion and is formed with an inclined face 29 diverging downwardly to form facing to the thin planar glass which is press-molded. The upper mold 17 is provided with the inner peripheral face of the cylindrical mold 26 slidably in the up and down direction.

The lower mold 14 is constituted by a lower mold main body 31 in a cylindrical shape and a support rod 32 formed at a central portion of a lower face of the lower mold main body 31 for supporting the lower mold main body 31 and a flat upper face of the lower mold main body 31 becomes a press surface (molding surface) 33. Further, by moving the support rod 32 upwardly and downwardly by driving means, not illustrated, the lower mold 14 is moved upwardly and downwardly. Further, there is formed a hollow portion 34 opened to a lower face of the support rod 32 at central portions of the lower mold main body 31 and support rod 32, further, at a lower mold portion at a surrounding of the hollow portion 34, there are formed 8 pieces of discharge holes 35 communicated with the hollow portion 34 at an inward portion of the hollow portion 34 and opened to a lower face of the support rod 32 as shown by the bottom view of FIG. 6. Here, water is sprayed to the hollow portion 34 along with air. The lower mold 14 is cooled by using the vaporization heat of sprayed water. The vaporized water is discharged from the exhaust holes 35. The cooling process is controlled in PID control by a signal from a thermocouple installed to the molds, the molds are controlled to a predetermined temperature and the molten glass can be molded by the mold which is maintained always at constant temperature even in continuous molding.

The lower mold 14 is provided with a barrel mold 36 to surround the lower mold 14 and the cylindrical mold 36 is constituted by a cylindrical mold main body 37 in a cylindrical shape and a flange portion 38 in a shape of circular ring formed by projecting to an inner side of a lower end portion of the lower mold main body 37. Here, an inner peripheral face of an upper face portion of the cylindrical mold main body 36 is provided with a diameter larger than that of other portion and the inner peripheral portion at a portion the diameter of which is changed to be large, constitutes an inclined face 39 diverging upwardly in order to form facing at the thin planar glass which is press-molded. The lower mold 14 is provided with the inner peripheral face of the cylindrical mold 36 slidably in the up and down direction.

The press face 33 of the lower mold 14 and the press face 23 of the upper mold 17 are formed in rough faces having the surface roughness (Ra) of, for example, 0.5 through 2.0 μm. The rough faces may be formed at a total of the press surfaces 33 and 23 or may be formed only at portions of the press surfaces 33 and 23. By molding the rough faces at the press surfaces 33 and 23, there can be achieved promotion of insulating performance, prevention of pasting of glass and promotion of adhering performance of the heat-resistant solid lubricant powder. Further, although according to the above-described constitution, there are formed the inclined faces for molding the facing portions at the inner peripheral faces of the cylindrical molds 26 and 36, the durability is promoted by the inclined face molding method in comparison with a method of molding inclined faces at the molds by projections or the like.

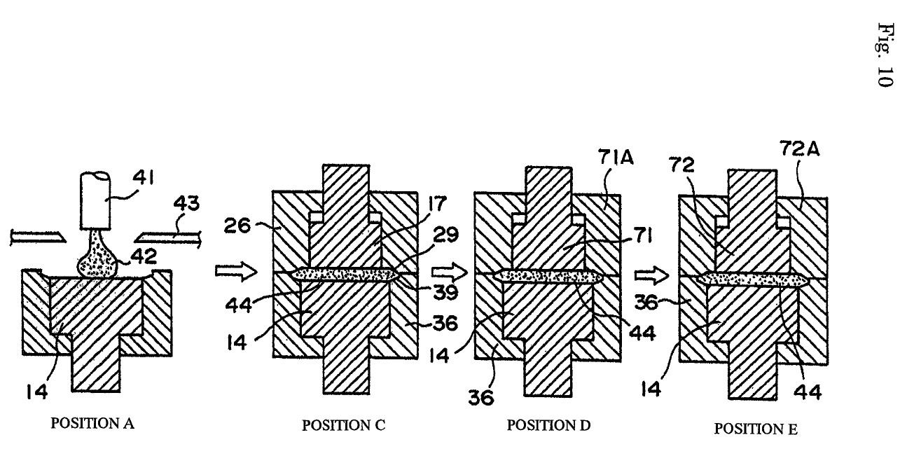

Other than the upper mold 17 and the lower mold 14 as described above, at positions D and E of FIG. 3, in order to carry out the warp correcting press, there are provided upper molds (molds) 71 and 72 for warp correcting press to be opposed to the lower molds 14 as shown by FIG. 10 (in FIG. 10, illustration of the hollow portions 24 and 34 and the discharge holes 25 and 35 is omitted). The upper molds 71 and 72 for warp correcting press are provided with cylindrical molds 71A and 72A and the constituted similar to the upper molds 17 for press-molding, described above, in this case. However, in contrast to 410° C. of temperature of the molding surface of the upper mold 17 for press-molding, temperature of the molding surface of the upper mold 71 for first warp correcting press is adjusted to 600° C. and temperature of the molding surface of the upper mold 72 for second warp correcting press is adjusted to 560° C., respectively.

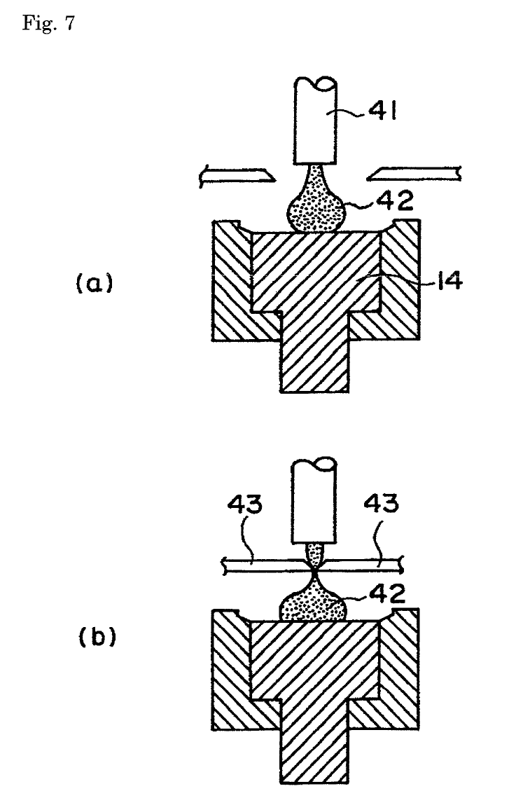

Next, an explanation will be given of a method of press-molding the thin planar glass in a shape of a disk by using the molding apparatus constituted as described above in reference to FIG. 3 and FIG. 7A through FIG. 10. Further, in FIG. 7A through FIG. 9B, similar to FIG. 10, for simplifying the drawings, illustration of the hollow portions 24 and 34 and the discharge holes 25 and 35 is omitted. When the lower mold 14 is rotated to position A of FIG. 3, as shown by FIG. 7A and position A of FIG. 10, molten glass 42 heated to 1200° C. is supplied from a pipe 41 made of platinum to the lower mold 14 (temperature of molding surface: 450° C.) by a constant flow rate and the molten glass 42 is cut by a cutting blade 43 as shown by FIG. 7B. The cut molten glass 42 constitutes glass gob in a shape of a marble rounded by surface tension. Next, when the lower mold 14 is rotated to position C of FIG. 3, as shown by FIG. 8A, the upper mold 17 (temperature of molding surface: 410° C.) is lowered integrally with the cylindrical mold 26 and the lower face of the cylindrical mold 26 is brought into contact with the upper face of the cylindrical mold 36 for the lower mold. Next, as shown by FIG. 8B and position C of FIG. 10, the upper mold 17 is lowered by sliding the inner peripheral face of the cylindrical mold 26 and the glass gob is press-molded by the upper mold 17 and the lower mold 14. Then, the glass gob is expanded fully to a space in a flat shape surrounded by the cylindrical molds 26 and 36 to thereby constitute thin planar glass 44. At this occasion, there are formed the facing portions for preventing chipping by the inclined faces 29 and 39 of the inner peripheral faces of the cylindrical molds 26 and 37. A time period required for the molding is about 1.7 seconds.

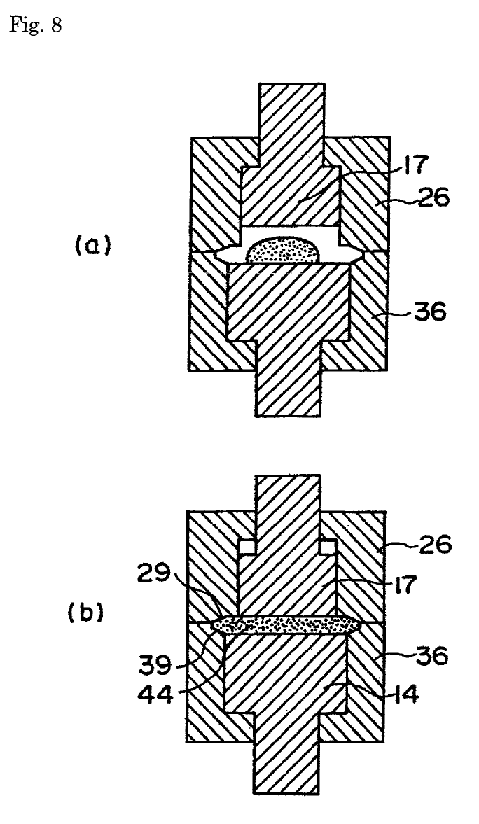

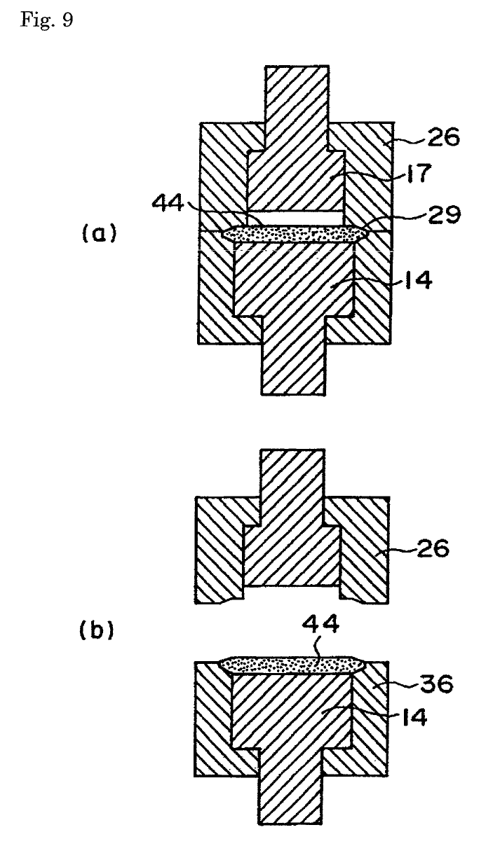

Next, as shown by FIG. 9A, the upper mold 17 is elevated by sliding the inner peripheral face of the cylindrical mold 26. At this occasion, although there is a concern that the thin planar glass 44 is elevated by being pasted to the upper mold 17, according to the apparatus, the thin planar glass 44 is pressed by an inner face (inner face portion of a portion having the inclined face 29) at a portion of the inner peripheral face having a large diameter in the lower face portion of the cylindrical mold 26 for the upper mold and accordingly, the thin planar glass 44 is not elevated integrally with the upper mold 17 and the thin planar glass 44 is held on the lower mold 14. Thereafter, as shown by FIG. 9B, the cylindrical mold 26 for the upper mold is elevated. At this occasion, an area of bringing the cylindrical mold 26 for the upper mold and the thin planar glass 44 into contact with each other is small and therefore, the thin planar glass 44 is not elevated by being pasted to the cylindrical mold 26 for the upper mold.

Next, when the lower mold 14 is rotated to position D of FIG. 3, as shown by position D of FIG. 10, the upper mold 71 and the cylindrical mold 71A for the first warp correcting press are lowered onto the lower mold 14 and the cylindrical mold 36 and the first warp correcting press is carried out to the thin planar glass 44 held on the lower mold 14. Further, when the lower mold 14 is rotated to position E of FIG. 3, as shown by position E of FIG. 10, the upper mold 72 and the cylindrical mold 72A for the second warp correcting press are lowered onto the lower mold 14 and the cylindrical mold 36 and the second warp correcting press is carried out to the thin planar glass 44 held on the lower mold 14. A time period required for one warp correcting operation is about 1.7 seconds. Thereafter, when the lower mold 14 is rotated to positions L through N of FIG. 3, the lower mold 14 is elevated by sliding the inner peripheral face of the cylindrical mold 36 and the thin planar glass 44 is removed. Thereafter, the lower mold 14 is rotated to positions O, P, A of FIG. 3 and is subjected again to press-molding. Further, the upper mold used in warp correction may be an upper mold 73 of FIG. 16 integrated with the upper mold 71 (or 72) and the cylindrical mold 71A (or 72A) of FIG. 10.

The thin planer glass which has been press-molded in this way, is molded to be thicker than a final product and as described above, both principal faces thereof are polished lapped out after undergoing the cooling step and the annealing step. In this case, according to the thin planar glass of the example, the magnitude of warp can be made constant to some degree, further, direction of warp can be made constant all to be a shape recessed upwardly. Therefore, in the successive lapping, the glass can be arranged to align the warp direction and can be lapped flatly with high accuracy. Conversely, when the direction of the warp is nonuniformly upward or downward, there are increased so-to-speak impertinent products in which lapping is not stabilized and the glass cannot be lapped and polished flatly with high accuracy. Here, it seems that the direction of the warp is all constant since the way of depriving heat of molten glass stays to be constant in any piece of the glass in the fabrication steps.

A detailed explanation will be given of mechanical working as follows. According to the mechanical working, specifically, the surface of the glass is cleaned by water and subjected to the following respective steps of (1) rough lapping, (2) lapping, (3) first polishing and (4) second polishing (final polishing).

(1) Rough lapping step

First, each of two faces of the glass substrate is lapped by a diamond grindstone having a fine particle size. Load at this occasion is set to about 100 kg. Thereby, the surface roughness of the two faces of the glass substrate is finished to about 10 μm in Rmax (measured by JIS B 0601). Next, a hole is perforated at a central portion of the glass substrate by using a grindstone in a cylindrical shape, an end face of an outer periphery thereof is also ground to thereby constitute a diameter of 65 mmΦ and predetermined facing is carried out to the end face of the outer periphery and an inner peripheral face.

(2) Lapping step

Next, lapping is carried out to the glass substrate. The lapping step is carried out with an object of promoting dimensional accuracy and shape accuracy. The lapping is carried out by using a lapping apparatus and is carried out twice by changing the particle size of abrasive grain to #400 and #1000. In details, firstly, there is used alumina abrasive grain having the particle size of #400 and by rotating an inner rotating gear and an outer rotating gear, the two faces of the glass substrate contained in a carrier are lapped to an accuracy of 0 through 1 μm and surface roughness (Rmax) of about 6 μm. In the lapping operation, the load is gradually increased from 80 kg to 120 kg. Next, the lapping is carried out by changing the particle size of the alumina abrasive grain to #1000 and the surface roughness (Rmax) is made to be about 2 μm. The glass substrate finished with the lapping is cleaned by successively dipping the glass substrate to respective cleaning tanks of neutral detergent and water.

(3) First polishing step

Next, the first polishing step is carried out. The first polishing step is carried out with an object of removing defect or strain left in the above-described lapping step and is carried out by using a polishing apparatus. In details, as a polisher (polishing powder), there is used a hard polisher (cerium pad MHCl: made by Speedfirm Co., Ltd.) and the first polishing step is carried out by the following polishing conditions.

Polishing solution: cerium oxide+water

Load: 300 g/cm² (L=238 kg)

Polishing time: 15 minutes

Removing amount: 30 μm

Lower level block rotational number: 40 rpm

Upper level block rotational number: 35 rpm

Inner gear rotational number: 14 rpm

Outer gear rotational number: 29 rpm

The glass substrate finished with the fist polishing step is cleaned by successively dipping the glass substrate in respective cleaning tanks of neutral detergent, pure water, pure water, IPA (isopylene alcohol) and IPA (vapor drying).

(4) Second polishing step

Next, the second polishing step is carried out by using the polishing apparatus used in the first polishing step and changing the polisher from the hard polisher to a soft polisher (Polilux: made by Speedfirm Co., Ltd.). The polishing conditions are made similar to those in the first polishing step except that the load is set to 100 g/cm², the polishing time is set to 5 minutes and the removing amount is set to 5 μm. The glass substrate finished with the second polishing step is cleaned by successively dipping the glass substrate in respective main tanks of neutral detergent, neutral detergent, pure water, pure water, IPA (isopylene alcohol) and IPA (vapor drying). Further, ultrasonic wave is applied to the respective cleaning tanks. In this way, there is provided the glass substrate for an information recording medium in a shape of a circular plate having the outer diameter of 65 mmΦ, the hole diameter at the central portion of 20 mmΦ, the thickness of 0.5 mm, Rmax of 40 Angstrom and Ra of about 8 Angstrom.

According to the fabricating method of the embodiment of the invention, a plurality of pieces of the lower molds 14 are arranged at the turn table 13, successively, the respective lower molds are transferred to the position for carrying out a pressing operation to thereby carry out the pressing step, the thin molded planar glass is taken out from the respective lower mold, the respective lower mold 14 is subjected again to fabrication of the thin planar glass and accordingly, the thin planar glass can be mass-produced. Further, although according to the above-described embodiment, the warp correcting press is carried out at position D and position E, the warp correcting press may be carried out at either of position D and position E when the flatness is not required so much. However, at the position F and thereafter, the thin planar glass 44 becomes excessively hard and tends to cause fissure or crack when the warp correcting press is carried out.

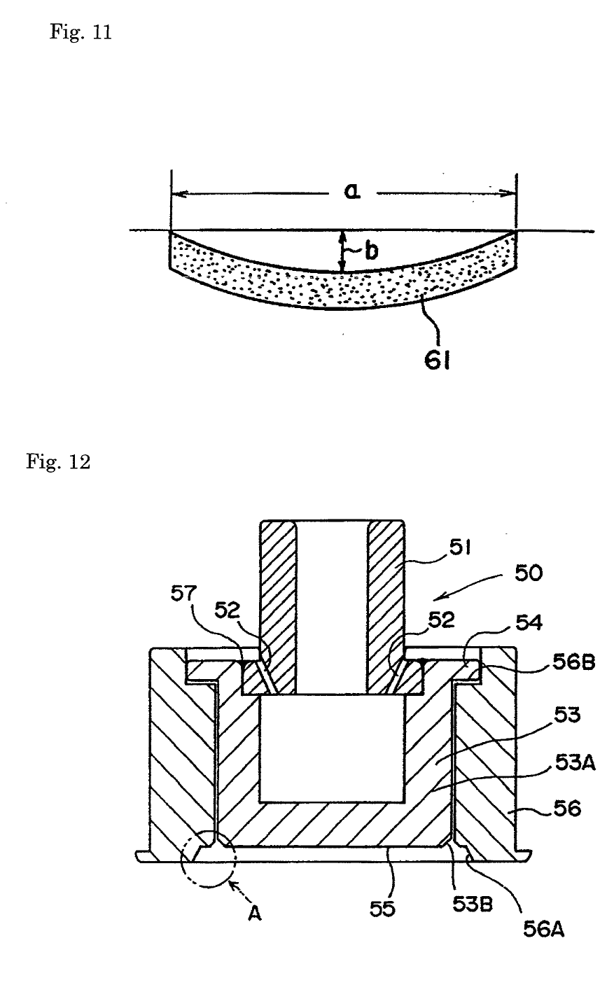

Further, although according to the above-described embodiment, as the upper mold of warp correcting press, there is used the upper mold similar to the upper mold of press-molding, there may be used an upper mold shown in FIG. 12 through FIG. 14. As shown by FIG. 12, an upper mold 50 is constituted by welding a small diameter cylindrical member 51 formed with a groove portion 52 constituting a path of air for cooling and a bottomed large diameter cylindrical member 53 formed with a flange 54 at an opening portion side thereof by a welding portion 57. The upper mold 50 is provided in a cylindrical mold 56 and the upper mold 50 is reciprocally moved along an axis line direction at inside of the cylindrical mold 56 by an air cylinder, not illustrated. Downward movement of the upper mold 50 is restricted by bringing the flange 54 in contact with a stepped face 56B formed on an inner side of an upper end portion of the cylindrical mold 56.

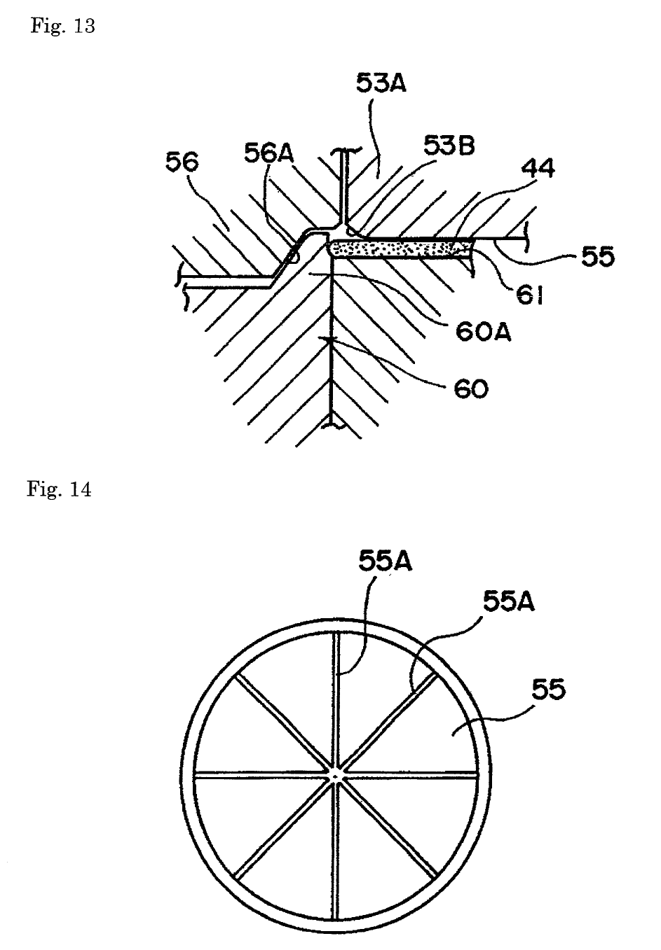

An outer diameter of a barrel portion 53A of the large diameter cylindrical member 53 of the upper mold 50 is smaller than a diameter of a press face 61 of a lower mold 60 shown in FIG. 13 (enlarged view of circle A portion of FIG. 12), further, a facing portion 53B is formed at a lower end portion of the barrel portion 53A over an entire peripheral direction thereof. Thereby, in the warp correcting press, a press face 55 of the upper mold 50 is not brought into contact with a peripheral edge portion of the thin planar glass 44 at which the cooling rate is fast and which is hardened the most and the thin planar glass 44 can be prevented from causing fissure or crack.

As shown by FIG. 14, the press face 55 of the upper mold 50 is radially formed with a plurality of grooves 55A in a shape of v. The respective grooves 55A are provided to make the thin planar glass 44 easy to detach from the press surface 55 of the upper mold 50 after the warp correcting press. Further, the warp correcting press is carried out when the thin planar glass 44 is provided with a hardness by which a shape thereof is not deformed and accordingly, the grooves 55A do not effect influence on the shape of the thin planar glass 44.

At an inner face of a lower end portion of the cylindrical mold 56, there is formed a groove 56A for alignment with the lower mold 60 shown in FIG. 13 over an entire peripheral direction thereof. Axis cores of the upper mold 50 and the lower mold 60 coincide with each other by constituting a state in which the groove 56A is fitted to a projected portion 60A of the lower mold 60.

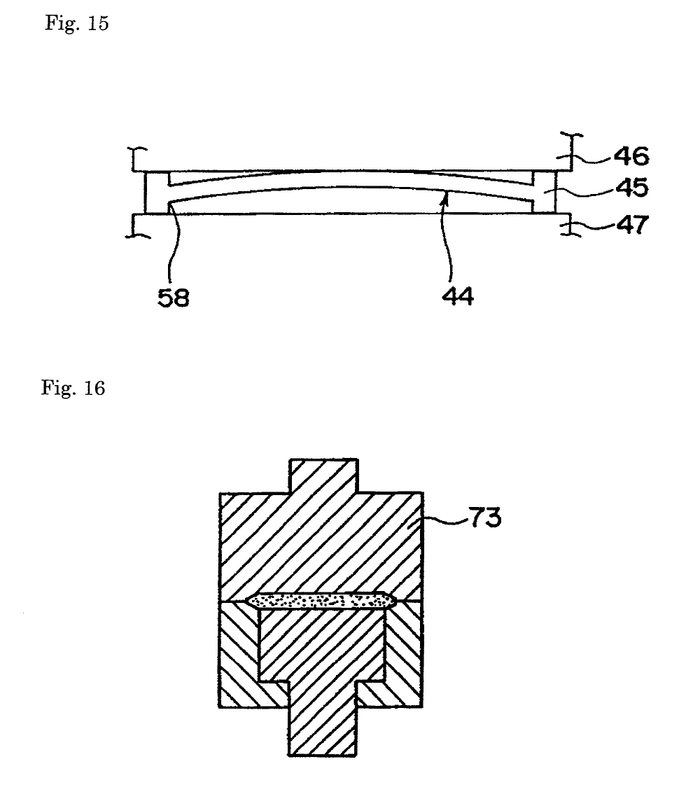

Further, such an upper mold 50 achieves an effect particularly when there is carried out warp correcting press of the thin planar glass 44 formed with a support portion 45, mentioned later, of FIG. 15 at an end portion of an outer periphery thereof. That is, the support portion 45 is provided with a portion projected to the side of the upper mold and accordingly, when the press surface 55 of the upper mold 50 is brought into contact with the projected portion, fissure or crack is easy to cause at a boundary portion 58 between the projected portion and a projected portion of the thin planar glass 44, however, when the facing portion 53B is formed at the upper mold 50, the press surface 55 of the upper mold 50 is prevented from being brought into contact with the support portion 45.

The press-molded thin planar glass is molded to be thicker than a final product and in order to constitute the final product, the two principal faces need to be lapped. At this occasion, when the thin planar glass is warped, the thin planar glass is bent when pressure is applied from the two face sides of the thin planer glass by polishing plates. Therefore, even when the thin planar glass polished under the state is made flat, the thin planar glass is warped again by releasing the pressure from two sides and the thin flat planer glass is difficult to provide. Hence, there may be provided portions of receiving the pressure from the two face sides of the thin planar glass at portions of the thin planar glass. As a specific example, as shown by FIG. 15, there is formed the support portion 45 (height: 1.5 mm) as a pressure receiving portion over an entire peripheral direction of the thin planar glass 44 at an end of an outer periphery of the thin planar glass 44, a thickness of a bent portion of which is 1.3 mm. It is preferable that the support portion 45 is formed in a state of being projected from respectives of the surface and the rear face of the thin planar glass 44. The reason is that when the surface of the thin planar glass 44 is projected more than the support port 45, in lapping, the bent portion of the thin planer glass 44 is brought into contact with an upper level block 46 before the support portion 45 is brought into contact with the upper level block 46, the state of the bent portion is changed and the thin planar glass 44 is warped after lapping.

As shown by FIG. 15, the thin planar glass 44 is arranged between the upper level block 46 and a lower level block 47, the thin planar glass 44 is lapped by applying pressure from the two face sides by level blocks 46 and 47 and the thin planar glass 44 is flattened and worked to predetermined wall thickness dimension. In the lapping, pressure from the two sides by the upper level block 46 and the lower level block 47 is received by the support portion 45 and therefore, the thin planar glass 44 is prevented from being bent and lapped in a state in which the bent state of the thin planar glass 44 is prevented from being changed. Therefore, even when pressure from the two sides by the upper level block 46 and the lower level block 47 is released, the thin planar glass 44 is not warped, the thin planar glass 44 and significantly excellent flatness is easy to provide. Further, by receiving the pressure from the two sides by the upper level block 46 and the lower level block 47 by the support portion 45, the bent portion of the thin planar glass 44 is prevented from moving and therefore, in the lapping step, it is not necessary to finely adjust pressure applied to the thin planar glass 44 such that the bent portion of the thin planar glass 44 is not moved, the thin planar glass 44 can be lapped efficiently and the thin planar glass 44 and excellent flatness can be mass-produced.

Further, in the above-described lapping operation, in a later half of the lapping, the lapping is progressed and an area of bringing the thin planar glass 44 into contact with the upper level block 46 (lower level block 47) is increased and accordingly, it is preferable to lap the glass by applying pressure larger than that in a former half thereof. Further, the support portion 45 may be provided to a side of a central portion of the end portion of the outer periphery of the thin planar glass other than the end portion of the outer periphery of FIG. 15. Further, the support portion 45 is easily provided by providing recess portions at the molding surfaces of the upper mold, the lower mold and the cylindrical mold.

Although the detailed description has been given of the invention as mentioned above, the above-described embodiment is naturally only a specific example. The specific constitutions of the upper mold apparatus and the lower mold apparatus, numbers of pieces of the upper molds and the lower molds, a relationship between the positions of the upper molds and the lower molds and the respective steps and the specific constitutions of the upper molds and the lower molds can be modified variously. Further, according to the upper mold and the lower mold, temperature of an inner surface of the cylindrical mold can be set to be higher than the surface temperature of the press surface. Further, the warp rate of the thin planar glass is pertinent to be about 0.01 through 1% and when the warp direction is constant to be one direction of either of the upper direction and the lower direction, in the later lapping, the glass can be polished flatly with high accuracy.

As has been explained, according to the invention, the thin planar glass and an excellent flatness can be fabricated with high mass production performance and accordingly, the glass substrate for an information recording medium having high quality and high function and the magnetic recording medium can be fabricated with high mass production performance.

What is claimed is:

1. A method of fabricating a planar molded glass article by pressing a glass material to be molded by using a mold at least comprising an upper mold and a lower mold, said method comprising:
a step of supplying the glass material to be molded having temperature higher than a glass transition point to a molding surface of the lower mold (supplying step);
a step of press-molding the supplied glass material by the lower mold and the upper mold to form a planar glass (pressing step);
a step of removing the upper mold from the planar glass and thereafter taking out the planer glass on the molding surface of the lower mold from the molding surface of the lower mold (taking out step);
a step of cooling the planar glass to temperature lower than a strain point of the glass (cooling step); and
a step of annealing the resulting planar glass (annealing step).

2. The method of fabricating according to claim 1, wherein said planar glass removed from the upper mold is taken out from the molding surface of the lower mold after the planar glass on the molding surface of the lower mold is cooled to a state in which the planar glass is not deformed by external force.

3. The method of fabricating according to claim 1 or 2, wherein said glass material supplied to the molding surface of the lower mold is molten glass.

4. The method of fabricating according to any one of claims 1 to 3, wherein the cooling step and/or the annealing step is carried out by placing the planar glass vertically.

5. The method of fabricating according to any one of claims 1 to 4, wherein after removing the upper mold from the planar glass during a time period until planar glass is taken out from the molding surface of the lower mold, warp of the planar glass is corrected by exerting external force to the planar glass.

6. The method of fabricating according to any one of claims 1 to 5, wherein a thickness of the planar glass molded article is equal to or smaller than 4 mm.

7. The method of fabricating according to any one of claim 1 to 6, wherein in a method of fabricating continuously a planar glass product by repeating a series of the steps from the supplying step to the annealing step, the lower mold after taken out of the planar glass from the molding surface, is adjusted to predetermined temperature and recycled to the supplying step.

8. A method of fabricating a glass molded article which is a method of providing a planar glass molded article by pressing a glass material to be molded by using a mold at least comprising an upper mold and a lower mold, taking out the resulting planar glass from the mold and annealing the planar glass, wherein said planar glass is annealed by placing the planar glass vertically.

9. The method of fabricating according to claim 8, wherein said planar glass is annealed by transferring the planar glass in a state of being placed vertically on transferring means in an annealing furnace.

10. A method of fabricating a glass substrate comprising at least polishing principal faces of the glass molded article prepared by the method of fabricating according to any one of claims 1 to 9 to give the glass substrate.

11. An information recording medium comprising the glass plate prepared by the method of fabricating according to claim 10 and an information recording layer provided on the principal face of said glass substrate.

12. An apparatus of fabricating a planar glass molded article comprising a mold at least comprising an upper mold and a lower mold for molding planar glass by pressing a glass material to be molded and an annealing furnace for annealing said planar glass, said apparatus comprising:
a transfer unit for transferring the planar glass to the annealing furnace after temperature of the planar glass taken out from the mold becomes lower than a strain point of the glass.

13. The apparatus of fabricating a according to claim 12, wherein said transfer unit is a means for transferring the planar glass in a vertically-placed state.

14. An apparatus of fabricating a planar glass molded article comprising a mold at least comprising an upper mold and a lower mold for molding planar glass by pressing a glass material to be molded and an annealing furnace for annealing the planar glass, said apparatus comprising:
a transfer unit for transferring the planar glass in a vertically-placed state in the annealing furnace.
